(19) United States
(12) Patent Application Publication
(10) Pub. No.: US 2026/0090533 A1
(43) Pub. Date: Apr. 2, 2026

(54) MONITORING APPARATUS FOR A TRAP DEVICE, PEST TRAP APPARATUS, AND SELF-CLEANING MECHANISM THEREOF

(71) Applicant: BARN OWL TECHNOLOGIES CORP., BOSTON, MA (US)

(72) Inventors: Richard CHEN, WELLESLEY, MA (US); Andrew Liang CHANG, BOSTON, MA (US); Rohan Matteo GIANCASPRO, BOSTON, MA (US)

(73) Assignee: BARN OWL TECHNOLOGIES CORP., BOSTON, MA (US)

(21) Appl. No.: 19/340,585

(22) Filed: Sep. 25, 2025

Related U.S. Application Data
(60) Provisional application No. 63/700,542, filed on Sep. 27, 2024.

(51) Int. Cl. A01M 1/02

(52) U.S. Cl. CPC A01M 1/026

(57) ABSTRACT

A monitoring apparatus adapted to be mounted to a trap device, includes an adapter module and a monitor module. The adapter module is attached to the trap device. The monitor module includes a casing separably attached to the adapter module, and a core system disposed in the casing. The core system includes a main board and a connectivity module. The connectivity module is coupled to the main board for communication with an external device.

### CROSS-REFERENCE TO RELATED APPLICATION

This application claims the benefit of U.S. Provisional Patent Application No. 63/700,542, filed on Sep. 27, 2024, the entire disclosure of which is incorporated by reference herein.

### FIELD

The disclosure relates to a pest trap apparatus, and more particularly to a monitoring apparatus for configurationally different trap devices.

### BACKGROUND

For capturing different kinds of pests, configurationally different trap devices may be employed. However, when remote monitoring is needed, each trap device may need to be equipped with a specific monitoring apparatus.

### SUMMARY

Therefore, an object of the disclosure is to provide a monitoring apparatus that can alleviate the drawback of the prior art.

According to the disclosure, the monitoring apparatus is adapted to be mounted to a trap device, and includes an adapter module and a monitor module. The adapter module is attached to the trap device. The monitor module includes a casing that is separably attached to the adapter module, and a core system that is disposed in the casing. The core system includes a main board and a connectivity module. The connectivity module is coupled to the main board for communication with an external device.

Another object of the disclosure is to provide a pest trap apparatus that can alleviate the drawback of the prior art.

According to the disclosure, the pest trap apparatus includes a trap device, an adapter module and a monitor module. The trap device includes a trap body. The adapter module is attached to the trap device. The monitor module includes a casing that is separably attached to the adapter module, and a core system that is disposed in the casing. The core system includes a main board and a connectivity module. The connectivity module is coupled to the main board for communication with an external device.

Another object of the disclosure is to provide a self-cleaning mechanism adapted to be mounted to a trap device for pushing a stack of trays one by one.

According to the disclosure, the self-cleaning mechanism includes a pusher and an actuator. The pusher is located at a height that corresponds to a height of a bottommost one of the stack of the trays, and is operable to move the bottommost one of the stack of the trays. The actuator is configured to drive movement of the pusher.

### BRIEF DESCRIPTION OF THE DRAWINGS

Other features and advantages of the disclosure will become apparent in the following detailed description of the example(s) with reference to the accompanying drawings. It is noted that various features may not be drawn to scale.

FIG. 1 is a perspective view illustrating an example pest trap apparatus.

FIG. 2 is a block diagram illustrating an example core system and an example extension system of the pest trap apparatus.

FIG. 3 is a fragmentary perspective view illustrating an example adapter module of the pest trap apparatus.

FIG. 4 is a perspective view illustrating an example monitor module of the pest trap apparatus.

FIG. 5 is a perspective view illustrating the example monitor module to be attached to the example adapter module.

FIG. 6A, FIG. 6B and FIG. 6C are schematic views illustrating engagement between an example adapter engaging structure and an example monitor engaging structure.

FIG. 7 is a fragmentary perspective view illustrating the example monitor module being attached onto the example adapter module.

FIG. 8 is a perspective view illustrating the example monitor module being attached onto the example adapter module.

FIG. 9A is a fragmentary perspective view illustrating contacts of an example Pogo pin connector.

FIG. 9B is an enlarged fragmentary perspective view illustrating the contacts of the example Pogo pin connector.

FIG. 10 is a fragmentary perspective view illustrating pins of the example Pogo pin connector.

FIG. 11 is a fragmentary perspective view illustrating additional pins of the example Pogo pin connector.

FIG. 12 is a fragmentary perspective view illustrating an example trap device.

FIG. 13 is a perspective view illustrating an example tray.

FIG. 14 is a fragmentary perspective view illustrating a plurality of example trays being stacked in a compartment of an example trap device.

FIG. 15 is a schematic side view illustrating an example self-cleaning mechanism.

FIG. 16 is a perspective view illustrating another example tray.

FIG. 17 to FIG. 20 are schematic side views illustrating action of the example self-cleaning mechanism.

FIG. 21 is a fragmentary perspective view illustrating another example leveling mechanism.

FIG. 22 is an exploded perspective view illustrating another example monitor module.

FIG. 23 is a perspective view illustrating an example monitoring apparatus and an example delta trap.

FIG. 24 is a perspective view illustrating the example monitoring apparatus being mounted to the example delta trap.

FIG. 25 is an exploded perspective view illustrating an example monitoring apparatus and the example pyramid trap.

FIG. 26 is a perspective view illustrating the example monitoring apparatus being mounted to the example pyramid trap.

FIG. 27 is an exploded perspective view illustrating an example monitoring apparatus and an example deadinn trap.

FIG. 28 is a perspective view illustrating the example monitoring apparatus being mounted to the example deadinn trap.

FIG. 29 is an exploded perspective view illustrating an example monitoring apparatus and an example sideway plate trap.

FIG. 30 is a perspective view illustrating the example monitoring apparatus being mounted to the example sideway plate trap.

FIG. 31 is an exploded perspective view illustrating an example monitoring apparatus and an example sticky ball trap.

FIG. 32 is a perspective view illustrating the example monitoring apparatus being mounted to the example sticky ball trap.

FIG. 33 is an exploded perspective view illustrating an example monitor module.

FIG. 34 is an exploded perspective view illustrating an example monitoring apparatus and an example delta trap.

FIG. 35 is a perspective view illustrating the example monitoring apparatus being mounted to the example delta trap.

FIG. 36 is an exploded perspective view illustrating an example monitoring apparatus and an example pyramid trap.

FIG. 37 is a perspective view illustrating the example monitoring apparatus being mounted to the example pyramid trap.

FIG. 38 is an exploded perspective view illustrating an example monitoring apparatus and an example deadinn trap.

FIG. 39 is a perspective view illustrating the example monitoring apparatus being mounted to the example deadinn trap.

FIG. 40 is an exploded perspective view illustrating an example monitoring apparatus and an example sideway plate trap.

FIG. 41 is a perspective view illustrating the example monitoring apparatus being mounted to the example sideway plate trap.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein May be interpreted accordingly.

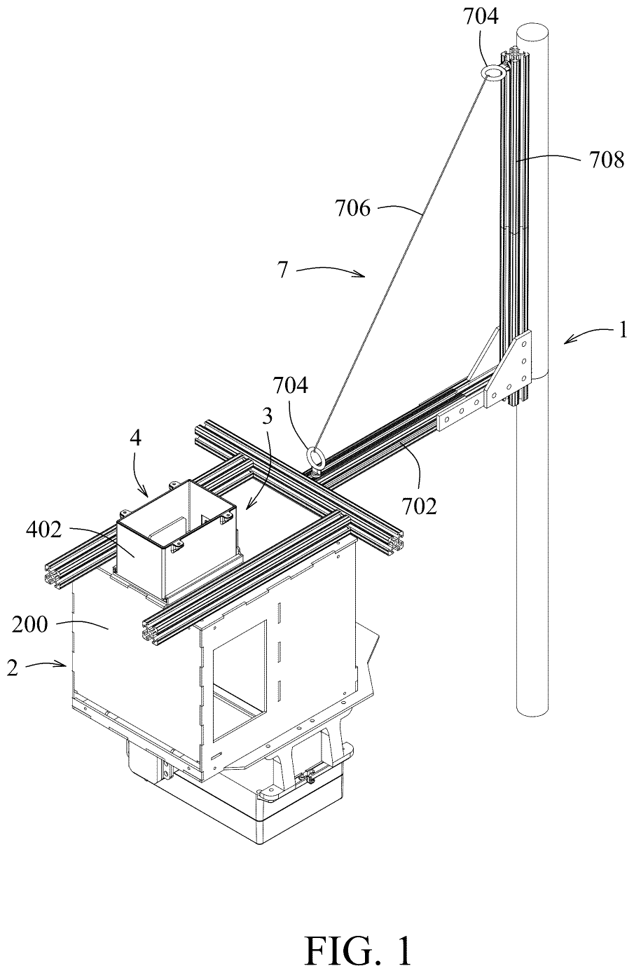

Referring to FIG. 1, an example pest trap apparatus may include a trap device 2 and a monitor module 4. The trap device 2 may include a trap body 200 for capturing pests. The monitor module 4 may be separably attached to the trap device 2. Generally, it is desired for the monitor module 4 to be attached to and detached quickly, conveniently yet robustly from the trap device 2. Accordingly, the example pest trap apparatus may further include an adapter module 3. The adapter module 3 may be attached to the trap device 2. The monitor module 4 may be separably attached to the adapter module 3. It should be noted that in the Figures of this disclosure, for the sake of a more clear illustration of the interior components of the pest trap apparatus, some of the wall segments of casing or housing components of the pest trap apparatus may be omitted, and should not be considered the actual shape of the casing or housing components of the pest trap apparatus.

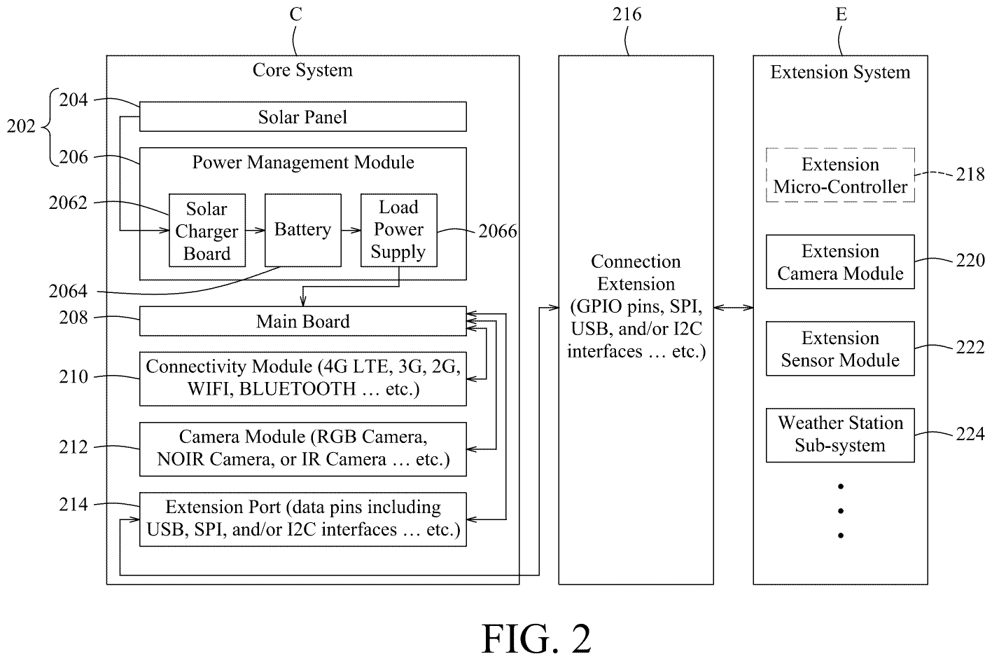

The monitor module 4 may include a casing 402 that houses electronic components such as microprocessors, cameras, connection cables, etc. Referring further to FIG. 2, for example, the monitor module 4 may include a core system (C) that is disposed in the casing 402 of the monitor module 4 and that may include a main board 208, and a connectivity module 210 coupled to the main board 208. In some examples, the main board 208 may include microprocessors, and may communicate with an external server (e.g., a cloud server) via the connectivity module 210. In some examples, the main board 208 may include microprocessors that store software instructions or firmware therein and that are capable of implementing functions as described in this disclosure. The connectivity module 210 may include components that support a variety of connections such as 4G LTE, 3G, 2G, Wi-Fi, Bluetooth, etc., for communication with an external device.

In some examples, the core system (C) may further include a camera module 212 that is connected to the main board 208 and that is for capturing images in the trap body 200. The camera module 212 may include one or more cameras that may be implemented using, for example, RGB cameras, NOIR cameras, IR cameras, etc.

In general, the cameras may include lenses that are specifically designed with respect to different trap devices (e.g., with a focus distance that is within a range such as from 5 to 13 centimeters or from 2 to 10 centimeters), so as to ensure that the images inside the trap body 200 that is within the focus distance and that are taken by the camera module 212 are clear enough for implementing image recognition operations by, for example, an external computer server. This configuration is particularly useful in the cases that the trap body 200 has a curved inner surface (e.g., a sphere), and different parts of the inside of the trap body 200 have different distances from the camera(s).

In some examples, the core system (C) may further include a power supply unit 202 for providing electric power. The power supply unit 202 may have various configurations. For example, the power supply unit 202 may include a solar panel 204 and a power management module 206. The power management module 206 may be connected to the solar panel 204 to receive the solar energy converted by the solar panel 204. In some examples, the power management module 206 may include a solar charger board 2062 that is connected to the solar panel 204, a battery 2064 that is connected to the solar charger board 2062, and a load power supply 2066 that is connected to the battery 2064. The solar panel 204 is configured to receive solar energy and charge the battery 2064. The load power supply 2066 may be configured to continuously supply the energy of the battery 2064 to the electronic components of the pest trap apparatus. For example, the main board 208 may be connected to the power management module 206 to receive electric power from the load power supply 2066 of the power management module 206.

In some examples, the core system (C) may further include extension port(s) 214. The extension port(s) 214 may be connected to the main board 208, and May include data transmission pins (e.g., General-purpose input/output (GPIO) pins, a USB interface, SPI, and I2C interface, etc.) that enable other external components to be connected to the core system (C).

In some examples, the pest trap apparatus may further include an extension system (E). The extension system (E) may be mounted on the trap device 2, and may be connected to the core system (C) via a connection extension 216. The connection extension 216 may be mounted on the trap device 2, and may include data transmission pins (e.g., General-purpose input/output (GPIO) pins, a USB interface, SPI, and I2C interface, etc.) for interconnecting the core system (C) and the extension system (E).

In some examples, the extension system (E) may include an extension microcontroller 218, an extension camera module 220 (e.g., USB or MIPI camera) that serves as an extension component to capture images outside of the trap device 2 (e.g., of a bud of a tree, another trap device nearby, etc.), an extension sensor module 222 (e.g., including one or more I2C sensors for sensing, for example, temperature, humidity, etc.), a weather station sub-system 224, or other suitable components that may provide other functionalities.

In some examples, the adapter module 3 may have an adapter engaging structure. The monitor module 4 may have a monitor engaging structure that is separably engaged with the adapter engaging structure of the adapter module 3 for position the monitor module 4 relative to the adapter module 3.

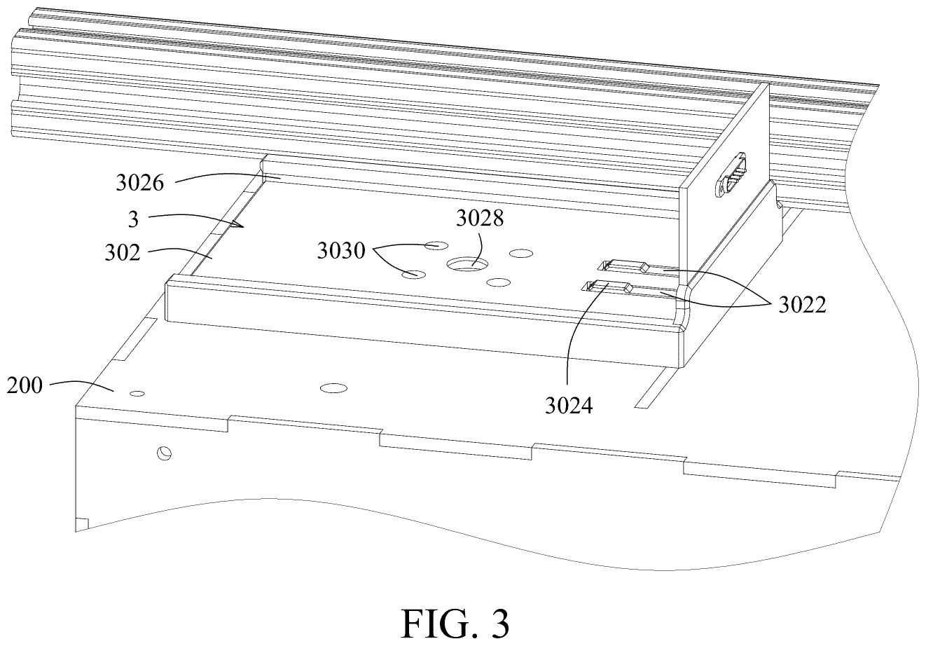

Referring to FIG. 3, in some examples, the adapter module 3 may include a clip plate 302 that is attached to the trap body 200. In some examples, the clip plate 302 may be formed with at least one flexible arm 3022 that serves as the adapter engaging structure. In some examples, the clip plate 302 of the adapter module 3 may be attached to the trap body 200 through bolt-fastening. In some examples, the clip plate 302 may be formed with a plurality of flexible arms 3022 that serve as the adapter engaging structure. Each of the flexible arms 3022 may have a nub 3024 at a free end thereof.

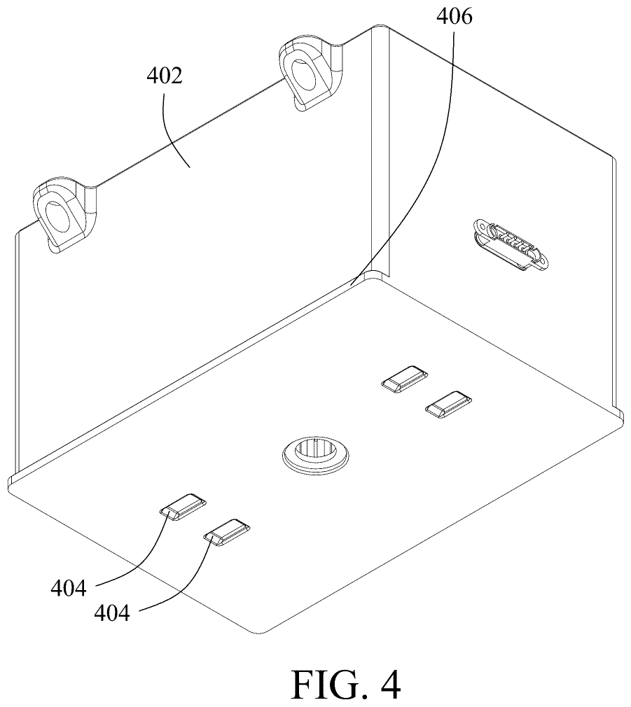

Referring further to FIG. 4, in some examples, the casing 402 of the monitor module 4 may be formed with at least one notch 404 that serves as the monitor engaging structure. In some examples, the casing 402 may be formed with a plurality of notches 404 that serve as the monitor engaging structure.

In some examples, the clip plate 302 may be formed with at least one guide groove 3026 (see FIG. 3) that cooperates with the flexible arm(s) 3022 to serve as the adapter engaging structure. The monitor module 4 may be formed with at least one guide protrusion 406 that is operable to slide along the guide groove 3026 to guide relative movement between the monitor module 4 and the clip plate 302, and that cooperate with the notch(es) 404 to serve as the monitor engaging structure.

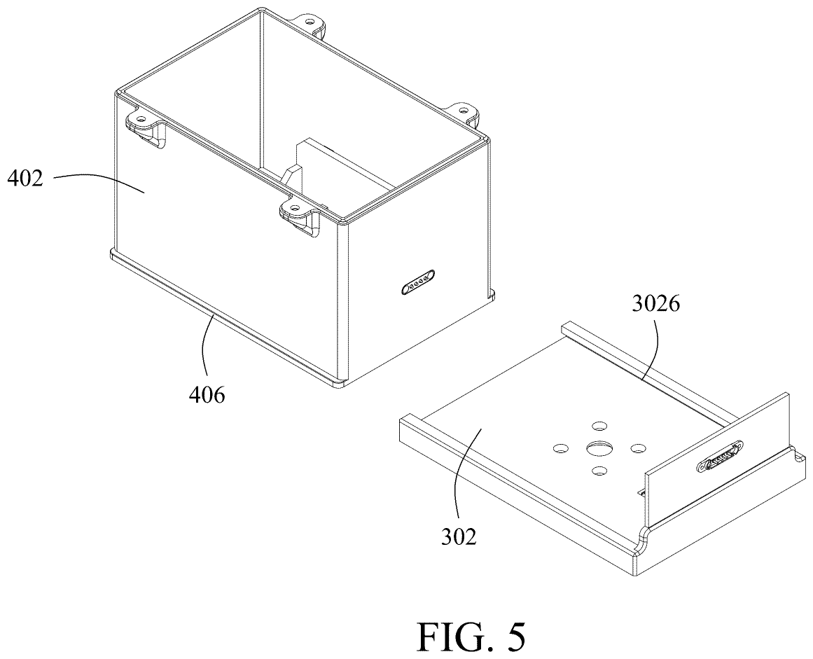

In some examples, the clip plate 302 may be attached to a top wall of the trap body 200, and may be formed with a plurality of guide grooves 3026, and two flexible arms 3022 (see FIG. 3) that protrude from a surface. Correspondingly, the monitor module 4 may be formed with two notches 404 in a bottom surface thereof, and a plurality of guide protrusions 406 that are operable to respectively and slidably engage the guide grooves 3026. Referring further to FIG. 5, in use, when it is desired to attach the monitor module 4 to the adapter module 3, the monitor module 4 may be easily slid relative to the adapter module 3 via the engagement between the guide protrusions 406 and the guide grooves 3026. It is noted that when the monitor module 4 slides over the clip plate 302 to respectively align the notches 404 with the nubs 3024 of the flexible arms 3022, the nubs 3024 of the flexible arms 3022 are configured to engage the notches 404, respectively. Therefore, the monitor module 4 may be easily positioned relative to the adapter module 3 and the trap device 2.

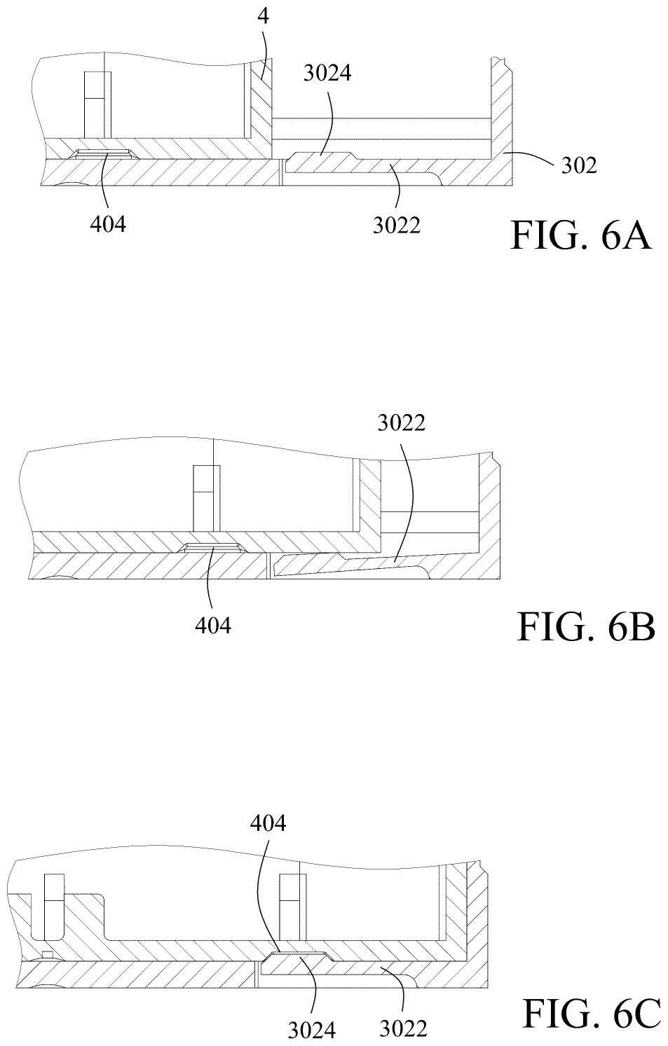

FIGS. 6A to 6C illustrate the flexible arm 3022 of the clip plate 302 being pressed to deform as the monitor module 4 is sliding over the flexible arm 3022, and finally engage with the notch 404 of the monitor module 4 so that the nubs 3024 of the flexible arms 3022 and the notch 404 of the monitor module 4 are locked together.

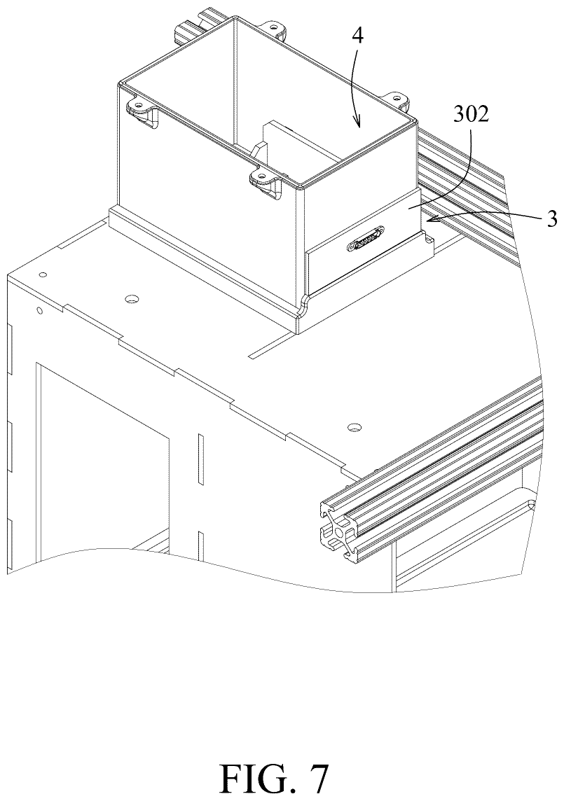

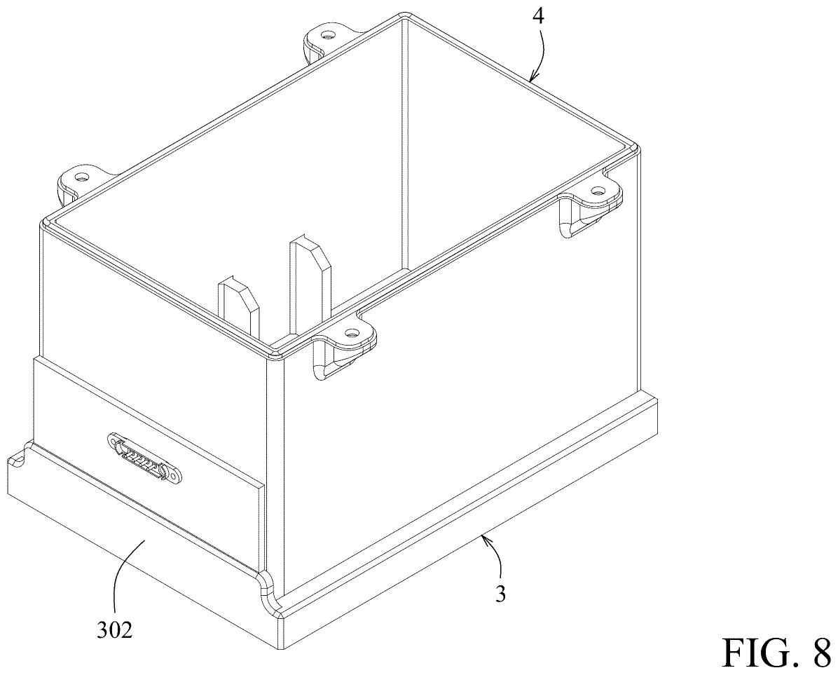

FIGS. 7 and 8 illustrate the monitor module 4 being positioned relative to the clip plate 302 of the adapter module 3.

In some examples, the clip plate 302 may use a passive spring mechanism using the elasticity of the PLA plastic parts. In some examples, the clip plate 302 may be formed with a camera aperture 3028 (see FIG. 3) that permitting the camera module 212 of the core system (C) to capture images inside the trap device 2 therethrough. In some examples, the clip plate 302 may be formed with a plurality of screw holes 3030 (see FIG. 3) for the clip plate 302 to be affixed to various trap devices and/or adapters.

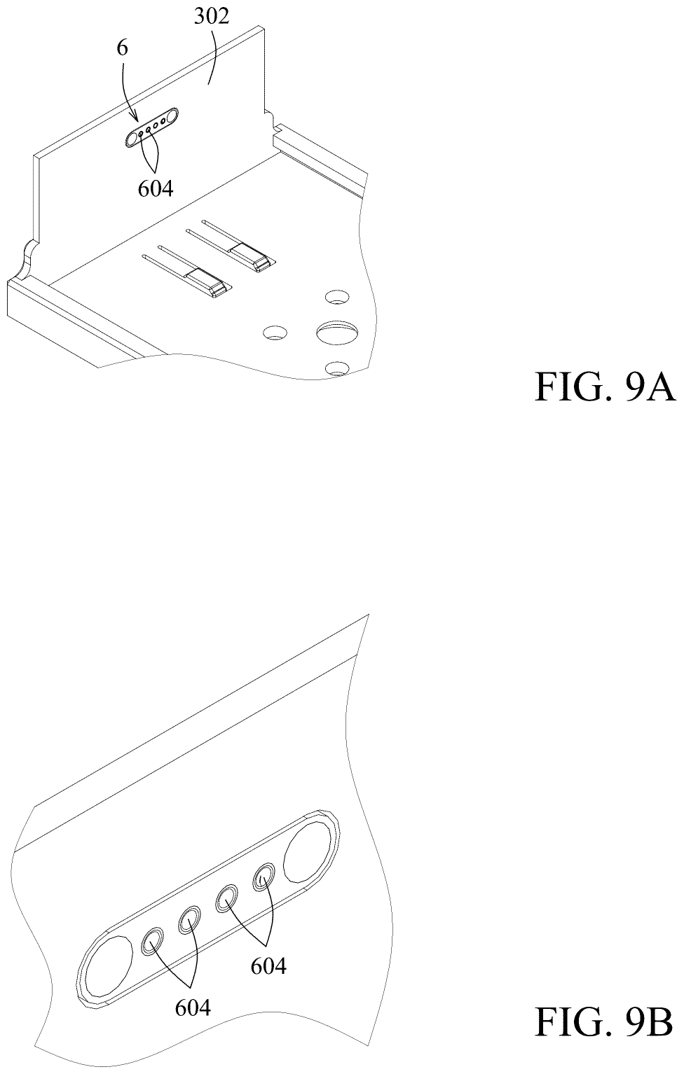

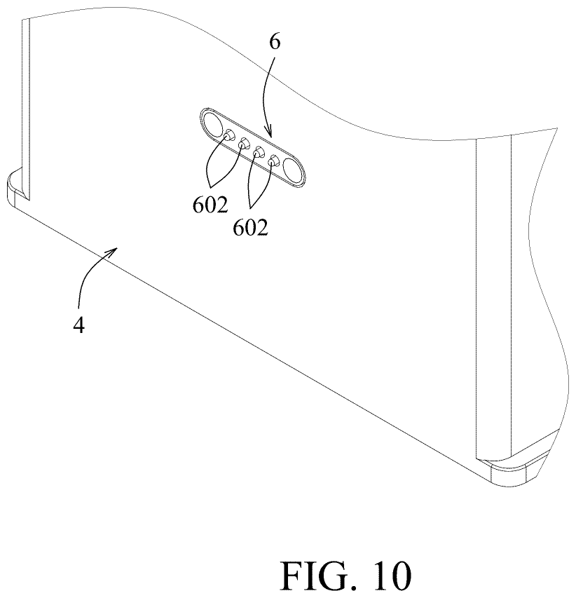

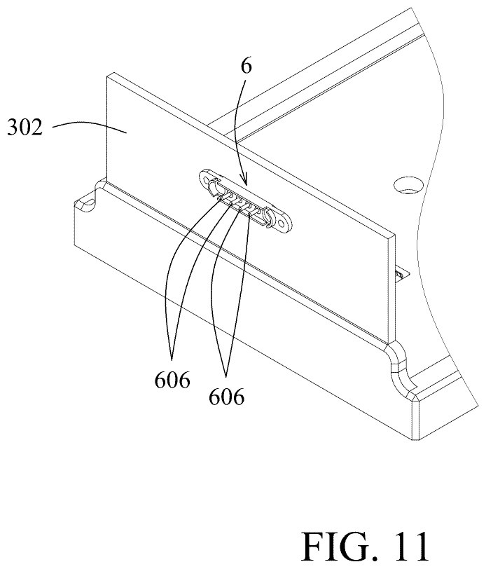

In some examples, after the monitor module 4 is positioned relative to the adapter module 3, a wired connection using a Pogo pin connector may be established. In some examples, the Pogo pin connector may be configured as a magnetic Pogo pin connector. For example, the magnetic Pogo pin connector may have four different pins on one side and four contacts on the other side. Referring to FIGS. 9A, 9B and 10, for example, the magnetic Pogo pin connector 6 may have four different pins 602 on the monitor module 4 and four contacts 604 on the clip plate 302. After the monitor module 4 is positioned relative to the clip plate 302 of the adapter module 3, the four pins 602 protruding from the monitor module 4 are coupled to the four contacts 604 on the clip plate 302, respectively. With reference to FIG. 11, the magnetic Pogo pin connector 6 may further have four additional pins 606 respectively coupled to the contacts 604 and protruding from the clip plate 302, and may be connected to an external system, allowing for signals and power to be passed in and out of the monitor module 4 to the rest of the components of the pest trap apparatus and any peripherals.

It is noted that while in the above examples, the pin connectors have four pins and four contacts for transmitting specific signals, in other examples, other kinds of connectors with additional pins and contacts may be employed for other applications.

In some examples, the casing 402 of the monitor module 4 may be generally made to be waterproof. It is also beneficial to have a waterproof method of communicating with other electronics on the monitor module 4 and any potentially peripheral electronics that are not inside the waterproof casing 402.

In some examples, a waterproof material (e.g., hot glue, silicone . . . etc) may be used to both secure the Pogo pin connector to through holes in the monitor module 4 as well as maintain the waterproof seal of the removable monitor module 4.

In some examples, the adapter module 3 and the monitor module 4 may cooperatively serve as a monitoring apparatus. Since the adapter module 3 (e.g., the clip plate 302) can be easily mounted to various kinds of trap devices, and since the camera module 212, the main board 208, the power supply unit 202, etc. can all be placed in the casing 402 of the monitor module 4, which can be quickly, conveniently and robustly attached to the adapter module 3, the monitoring apparatus according to the disclosure can be used with various kinds of trap devices with the Pogo pin style of electrical connection allowing for a “plug and play” style of operation. For example, the monitoring apparatus May be easily coupled to an extension system on a trap device via the “plug and play” style of operation.

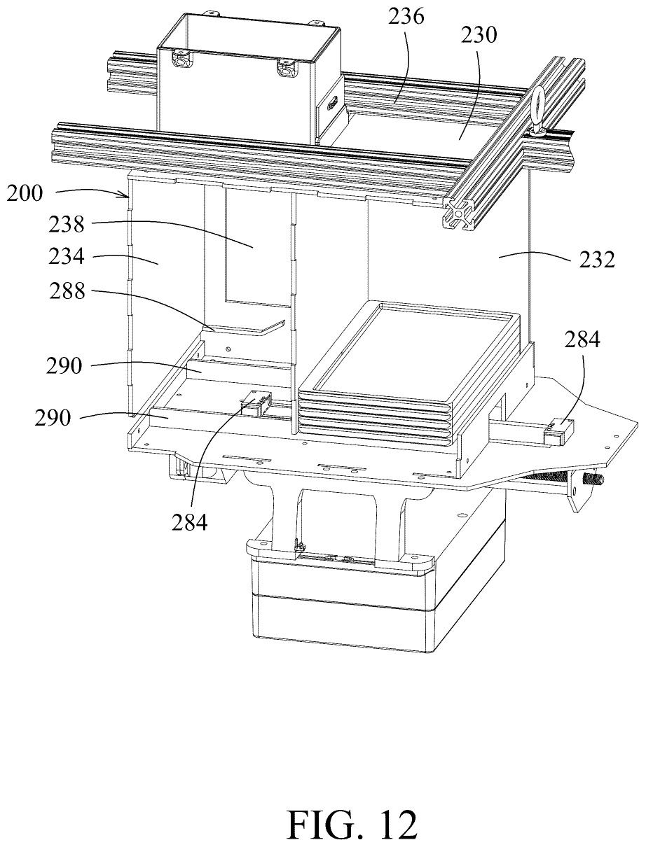

The trap body 200 may have various configurations. Referring to FIG. 12, for example, the trap body 200 may include a container 230 that is divided into a plurality of compartments. In some examples, the container 230 may be configured as an acrylic box. In some examples, the container 230 may be transparent. In some examples, the container 230 may be divided into a first compartment 232 and a second compartment 234.

In some examples, the trap device 2 may further include a support structure 236 to which the trap body 200 is attached. In some examples, the support structure 236 may be formed using a metal material such as Aluminium, and is configured for supporting the trap body 200 which is disposed below the support structure 236.

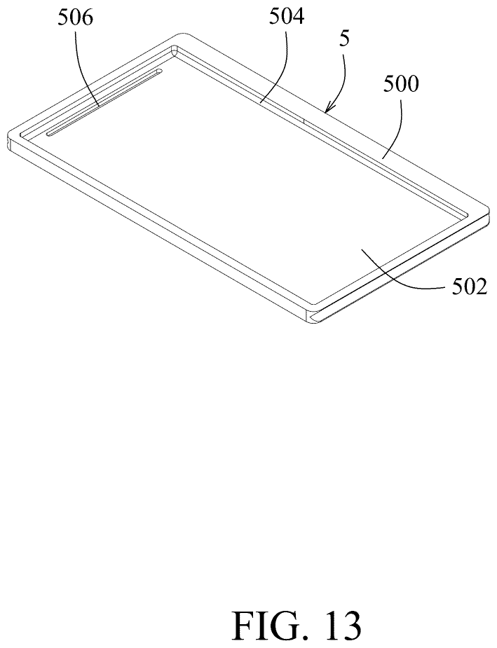

The trap device 2 may store, move, use, and discard a plurality of discrete trays 5. Referring to FIG. 13, in some examples, each of the trays 5 may include a tray body 500 with an indentation 504, and a drain hole 506 that is formed through the tray body 500 and that is in spatial communication with the indentation 504. In some examples, a bottom surface 502 of the indentation 504 has a slight slope which directs rainwater to drain through the drain hole 506. In some examples, the bottom surface 502 of each of the trays 5 may be applied with adhesive for trapping and observing flies and/or other target insects thereon. In some examples, the bottom surfaces 502 of the indentation 504 of the trays 5 may have other structures for trapping specific kinds of pests.

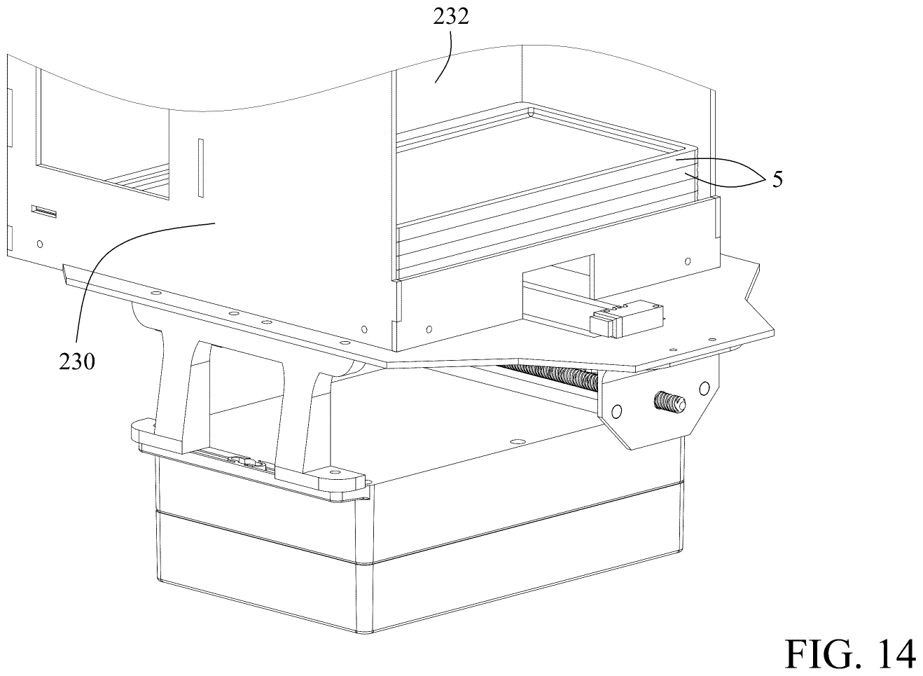

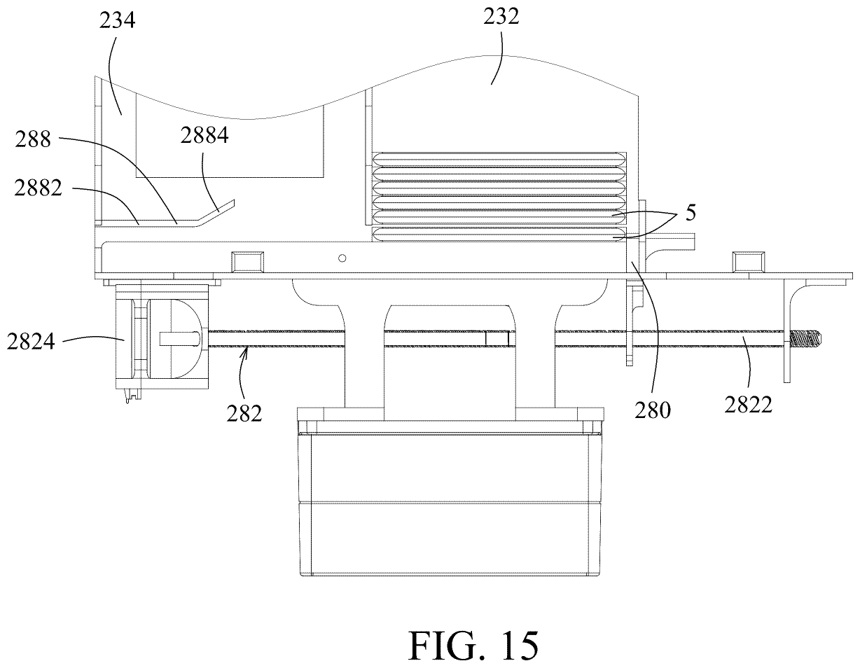

Referring to FIGS. 14 and 15, in some examples, the trays 5 may be stored in the first compartment 232 of the container 230 in a stack. This stack may be referred to as a magazine arrangement.

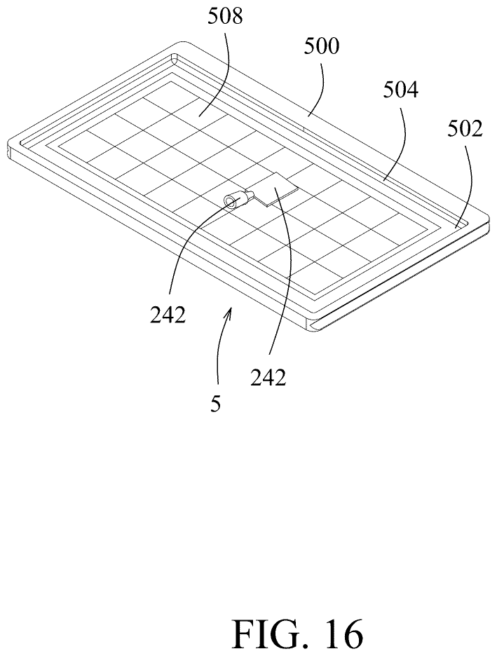

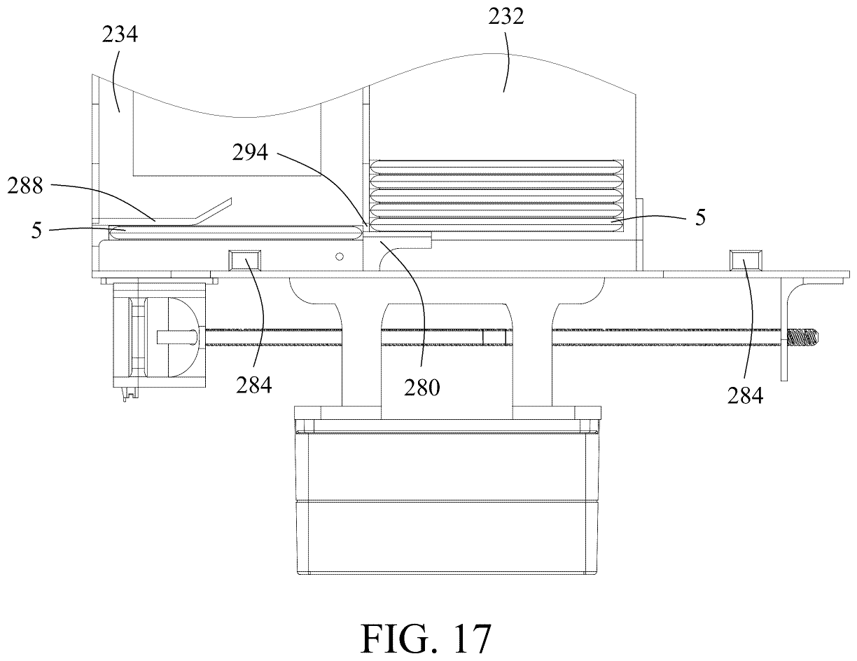

Referring to FIG. 17, in use, one of the trays 5 in the stack may be pushed out from the stack of the trays 5 in the first compartment 232 to the second compartment 234 of the container 230. In some examples, the second compartment 234 may have one or more side holes 238 (see FIG. 12) and may contain a specific substance for luring pests into the second compartment 234. For example, at least one lure 242 may be placed on the tray in the second compartment 234. In some examples, the lure 242 may be configured as a plastic object filled with pheromone. When a temperature is increased over a threshold, the pheromone may be released from the plastic object into the air. Referring to FIG. 16, in some examples, each of the trays 5 may be provided with a liner 508 applied with adhesives, placed on bottom surface 502 of the indentation 504 of the tray body 500, and fixed onto the tray body 500 using, for example, double-sided tape. The lure(s) 242 may be glued on the liner 508.

After being lured by the pheromone and moving inside the second compartment 234 through the side hole 238, the pest may be glued onto the liner 508 on the tray 5 (e.g., the top surface of the liner 508, as shown in FIG. 16). In some examples, the second compartment 234 may have a top hole (not visible) for enabling placement of the camera module 212 of the core system (C) (see FIG. 2) for observation.

Referring back to FIG. 15, the trap device 2 may further include a pusher 280 that is movable between an initial position (see FIG. 15) and a pushing position (see FIG. 17) for pushing one of the stack of the trays 5 in the first compartment 232 to the second compartment 234. The pusher 280 may be driven by an actuator 282 to push the bottommost one of the stack of the trays 5 in the first compartment 232 into the second compartment 234 (in a direction from the right to the left as seen in FIG. 15). The trap device 2 may further include an actuator control module for control of the actuator 282. In some examples, the actuator 282 may be configured as a linear actuator that includes a leadscrew 2822, a motor 2824 that is coupled to the leadscrew 2822 for driving rotation of the leadscrew 2822, and at least one guide rod (not shown). In some examples, the trap device 2 may further include two limit switches 284 that are disposed on a floor plate of the container 230 (see FIG. 12). The limit switches 284 are spaced apart from each other along a direction in which the pusher 280 is moved. In some examples, when the pusher 280 is moved and comes into contact with either one of the limit switches 284, it may be determined that the pusher 284 has been moved to a limit location and should not be driven further. As such, in the case that the pusher 280 is moved and comes into contact with one of the limit switches 284, a controller of the actuator control module controls the actuator 282 to actuate the pusher 280 to stop moving toward the one of the limit switches 284 or to move in an opposite direction toward another one of the limit switches 284. In some examples, when a distance between the pusher 280 and either one of the limit switches 284 is smaller than a predetermined value, it may be determined that the pusher 284 has been moved to a limit location and should not be driven further toward the one of the limit switches 284. In some examples, the pusher 280 may be controlled to move in other fashions (e.g., moving or oscillating between the limit switches 284).

In some examples, the actuator control module may be embodied using a microprocessor separated from the monitor module 4 and disposed near the actuator 282. In some examples, some electronic component(s) of the pest trap apparatus other than the core system (C) may be disposed in the monitor module 4, and is not limited to the above examples.

Referring back to FIGS. 12 and 15, in some examples, the trap device 2 may further include a guide member 288 disposed in the second compartment 234. The guide member 288 may be disposed at a height that is capable of containing a combined height of the tray body 500, the liner 508 and the lure(s) 242 (e.g., slightly larger than the combine height to accommodate the presence of the liner 508 and the lure(s) 242, see FIG. 17), and has a first part 2882 that extends horizontally from a side wall located at one side of the second compartment 234 distal from the first compartment 232, and a second part 2884 that extends from the first part 2882 in an upward angle (e.g., about 40-50 degrees) toward the first compartment 232. In this manner, when the pusher 280 from the right of the first compartment 232 is driven to move to the left so as to push the bottommost one of the stack of the trays 5 to the left, the tray 5 pushed by the pusher 280 can be secured at a predetermined position by the guide member 288 (see FIG. 17) in the second compartment 234 without bringing the potential issue of the trays 5 being jammed or misplaced.

In some examples, in addition to the guide member 288, the trap device 2 may further include two sliding rails 290 that are disposed on the floor plate of the container 230 as shown in FIG. 12. In this manner, as one of the trays 5 is pushed into the second compartment 234, the tray 5 is in contact with the sliding rails 290, and the movement of the one of the trays 5 is done without the tray 5 being in contact with the floor plate of the container 230. As such, the movement of the tray 5 within the container 230 may be smoothened. In addition, the disposal of additional components (e.g., bolts, the limit switches 284, and/or brackets to be attached to the floor plate) may not interfere with the movement of the tray 5.

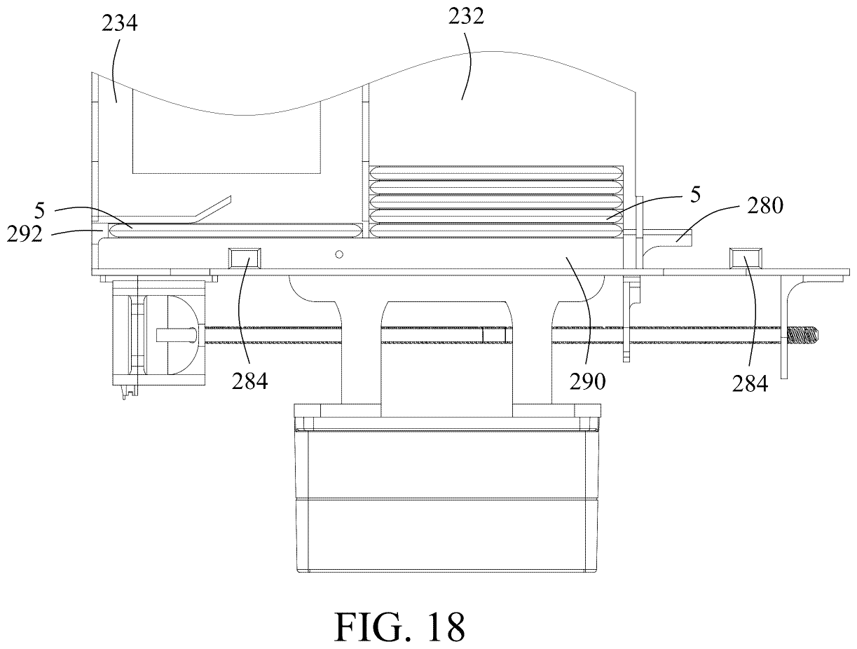

Referring to FIG. 17, when the pusher 280 moves from the initial position to the pushing position, a bottommost one of stack of the trays 5 in the first compartment 232 is pushed into the second compartment 234 via a trap entrance 294 by the pusher 280. In some examples, when the pusher 280 reaches the pushing position, the left one of the limit switches 284 in FIG. 17 detects the position of the pusher 280 for stopping further movement of the pusher 280 away from the right one of the limit switches 284. Referring to FIG. 18, when the pusher 280 moves back to the initial position, the remaining trays 5 in the first compartment fall onto the sliding rails 290 and are supported by the sliding rails 290. In some examples, when the pusher 280 reaches the initial position, the right one of the limit switches 284 in FIG. 18 detects the position of the pusher 280 for stopping further movement of the pusher 280 away from the left one of the limit switches 284.

After a specific condition (e.g., after a certain time has passed or a number of pests on the tray 5 in the second compartment 234 is more than a threshold) is met, a self-cleaning procedure may be initiated to remove the tray 5 in the second compartment 234, and to place another tray 5 to replace the tray 5 in the second compartment 234.

Referring to FIG. 18, in some examples, the container 230 may be formed with an exit opening 292 that is distal from the first compartment 232 and that is in spatial communication with the second compartment 234. At this stage, one tray 5 is in the second compartment 234, a plurality of trays 5 are stacked in the first compartment 232, and the pusher 280 is at the initial position, is beside the first compartment 232, and is located at a height that corresponds to the height of the bottommost one of the stack of the trays 5 in the first compartment 232.

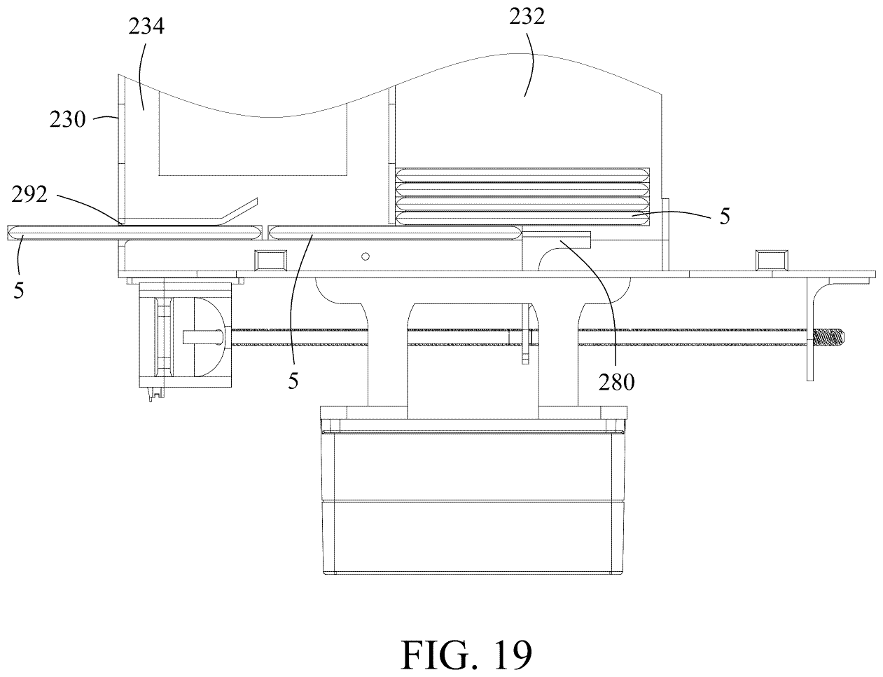

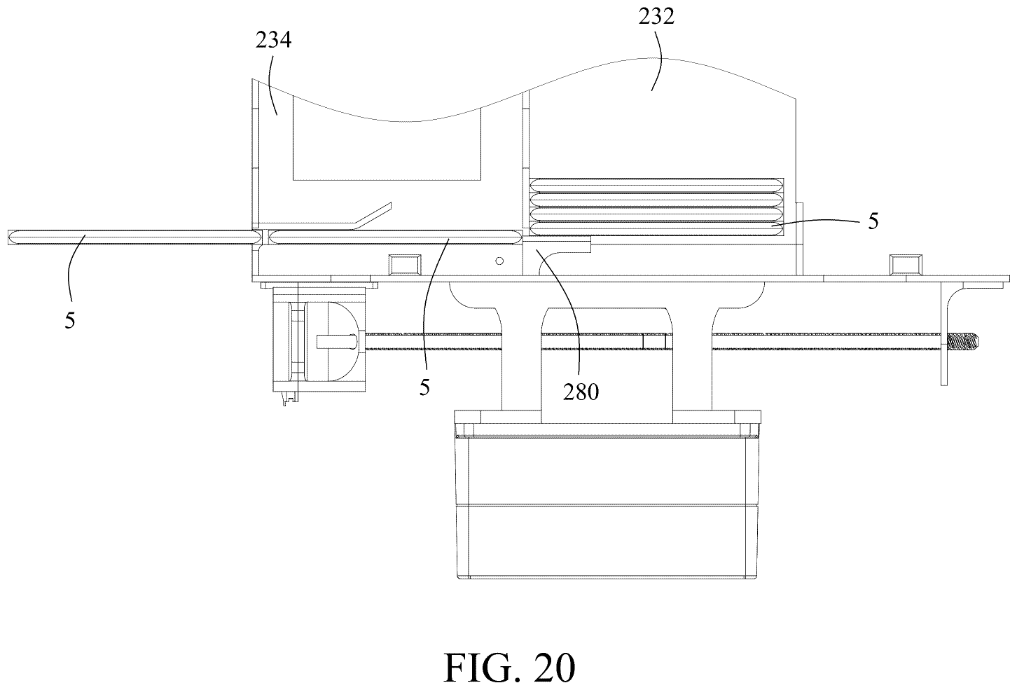

Referring to FIGS. 19 and 20, when the self-cleaning procedure is initiated, the pusher 280 moves from the initial position toward the pushing position to push the bottommost one of the stack of the trays 5 in the first compartment 232 into the second compartment 234. The bottommost one of the trays 5 in turn pushes the tray 5 that is already in the second compartment 234, which is pushed through the exit opening 292 out of the second compartment 234. In some examples, the tray 5 pushed out of the second compartment 234 may be dropped into a discard box/chamber (not shown), and the bottommost one of the stack of the trays 5 in the first compartment 232 is moved into the second compartment 234 to take its place. Afterward, the pusher 280 is driven to move back to the initial position to finish the self-cleaning procedure.

In some examples, the pusher 280 may be adjacent to one of the limit switches (hereinafter referred to as first limit switch) when the pusher 280 is at the initial position, and may come into contact with another one of the limit switches (hereinafter referred to as second limit switch) when the pusher 280 moves to the pushing position. In this example, when the self-cleaning procedure is initiated, the pusher 280 is moved from the initial position toward the pushing position to push the bottommost one of the stack of the trays 5 in the first compartment 232 into the second compartment 234. The bottommost one of the trays 5 in turn pushes the tray 5 that is already in the second compartment 234 out of the second compartment 234. After the pusher 280 reaches the pushing position and comes into contact with the second limit switch, the pusher 280 is determined not to further move toward the second limit switch and to move back toward the first limit switch. When the pusher 280 moves back to the initial position and comes into contact with the first limit switch, the pusher 280 is determined not to further move toward the first limit switch and to stop from moving.

In this disclosure, the pusher 280, the actuator 282, the limit switches 284, the actuator control module and the guide member 288 may cooperatively serve as a self-cleaning mechanism.

It is noted that, in some examples, the trap device 2 may be provided with a cover that covers one side the trap body 200. The cover may be beneficial in the case that the trap device is to be mounted in an outdoor location.

It is noted that the abovementioned self-cleaning mechanism works best when the trap body 200 of the trap device 2 is mounted level (i.e., in a horizontal position). However, with actual implementation in the field, the pest trap apparatus may be attached to a support stand (e.g., a mounting tripod/pole) that stands on rough and/or uneven terrain, and the trap body 200 of the trap device 2 thus may not be level. In some examples, the trap body 200 may be attached to a support stand or a tree using hose clamp(s).

Referring back to FIG. 1, in some examples, the pest trap apparatus may further include a leveling mechanism 7 for ensuring the trap body 200 of the trap device 2 to be level. An example leveling mechanism 7 may include a support arm 702, two eye bolts 704 and a robust metal wire 706. The support arm 702 may be rotatably mounted (e.g., hinged) to the support stand 1, and may hold the trap device 2 distal from the support stand 1. This allows the trap device 2 to be perfectly positioned in the level orientation upon set up. The eye bolts 704 may be respectively mounted to the support stand 1 and the support arm 702. After the support arm 702 is rotated relative to the support stand 1 such that the trap body 200 of the trap device 2 is level, the metal wire 706 may be tied between the eye bolts 704 to keep the support arm 702 at the proper angle to keep the device level. The metal wire 706 may be loosened from at least one of the eye bolts 704 for further adjustment of the orientation of the support arm 702. In some examples, the leveling mechanism 7 may further include an auxiliary arm 708 (see FIG. 1) that is attached to the support stand 1. The support arm 702 may be rotatably mounted (e.g., hinged) to the auxiliary arm 708. The eye bolts 704 may be respectively mounted to the auxiliary arm 708 and the support arm 702. In some examples, the auxiliary arm 708 may be attached to the support stand 1 by hose clamp(s) (not shown).

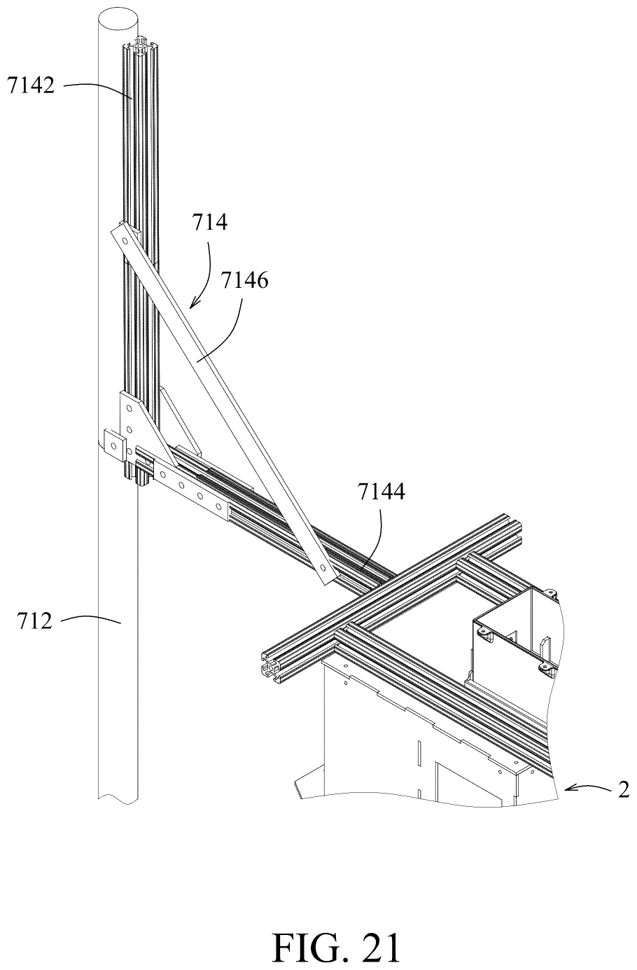

Referring to FIG. 21, in some examples, the leveling mechanism 7 may include a tripod (not shown) that is placed on a ground, an upright rod 712 that extends upward from the tripod and that may be formed using a wood material or a metal material, and a mounting frame 714 that is connected to the upright rod 712 and the trap device 2. The mounting frame 714 may include a first support beam 7142 that is attached to the upright rod 712, a second support beam 7144 that is hinged to a lower end of the first support beam 7142 and that is connected to support the trap device 2, and a third support beam 7146 that two opposite ends respectively connected to the first support beam 7142 and the second support beam 7144 using, for example, bolts. At least one of the opposite ends of the third support beam 7146 may be movable relative to the respective one of the first support beam 7142 and the second support beam 7144 to adjust the orientation of the second support beam 7144. The example leveling mechanism 7 allows the trap device 2 to be level when standing on a rough and uneven terrain. In some examples, the mounting frame 714 may include two third support beams 7146 each of which is connected to both the first support beam 7142 and the second support beam 7144 using bolts. In some examples, the first support beam 7142 may be attached to the upright rod 712 by hose clamp(s) (not shown).

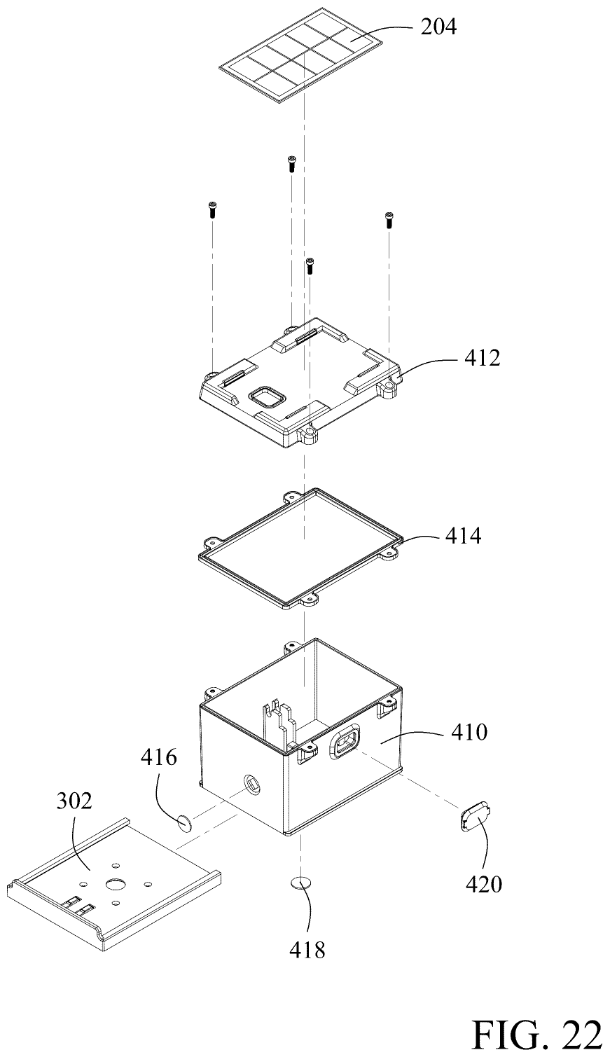

Referring to FIG. 22, in some examples, the monitor module 4 may include a casing 410, a lid 412, a gasket 414, a status lens 416, a camera lens 418 and a switch plug 420. The gasket 414 may be printed from TPU at 100% infill density to better insure against water intake. The casing 410 may be printed from PLA plastic, with insets for appropriate M3 bolt and nut fasteners and the gasket 414. The gasket 414 lines an inner periphery of the casing 410 (similar to a tupperware container). The solar panel 204 may be disposed on the lid 412. In some examples, the solar panel 204 may be firmly attached onto the lid 412 by adhesive(s) (e.g., silicone, industrial glue . . . etc). An additional gasket may line an inner periphery of a top opening of the lid 412 where solar panel wiring enters the casing 410. The status lens 416 may be mounted to a side opening of the casing 410. The camera lens 418 may be mounted to a bottom opening of the casing 410. The switch plug 420 may be mounted to another side opening of the casing 410 where a power switch is located.

In some examples, to address the issue that the location of the power switch may be inconvenient for the user, an extension arm from the circuit board switch component may be employed to reach to the location of the central switch for a more seamless user experience (and to get out of the way of the M3 screw fastener location).

As mentioned in the previous paragraphs, the adapter module 3 and the monitor module 4 that contains the core system (C) may cooperatively serve as a monitoring apparatus that may be suitable for various configurationally different trap devices 2. The monitoring apparatus according to the disclosure may also be suitable for commercially available trap devices with various configurations.

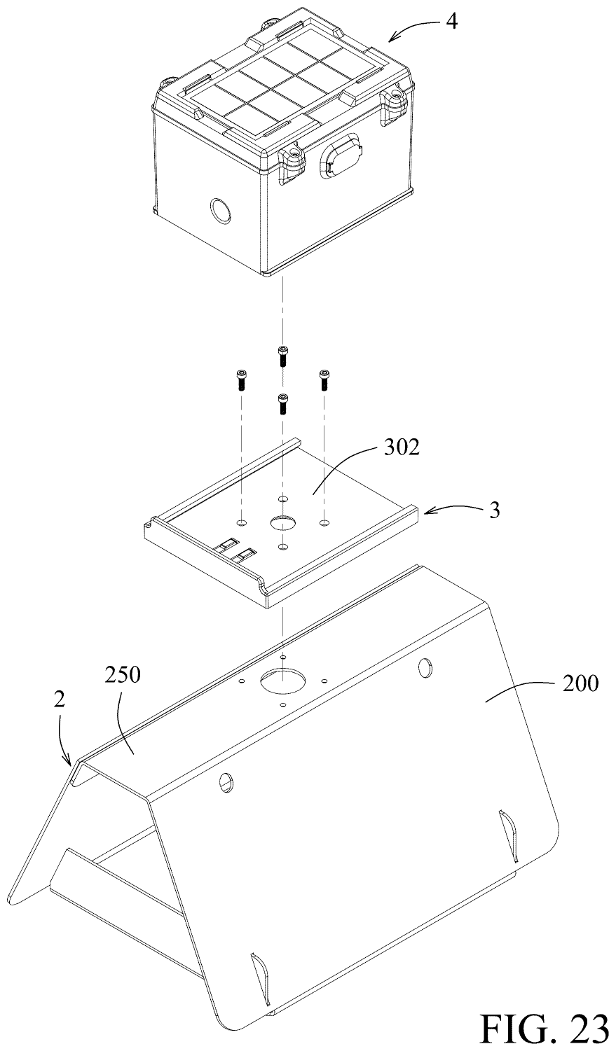

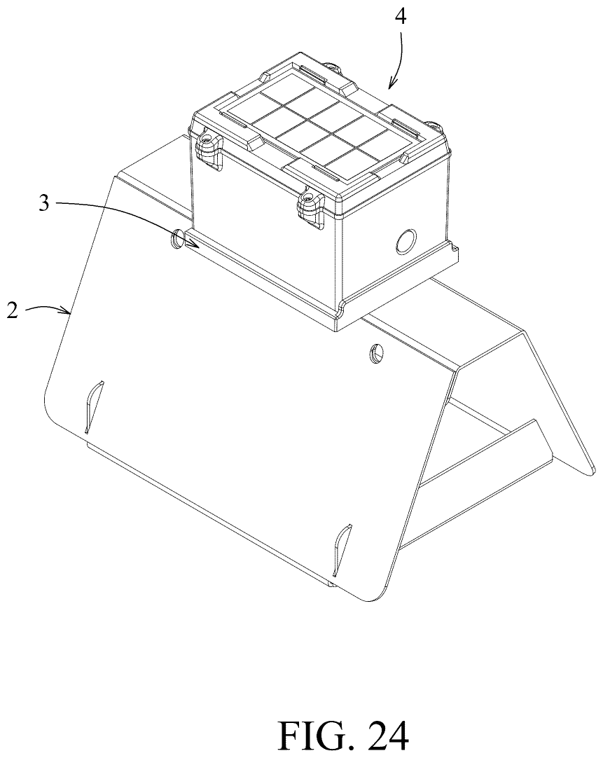

Referring to FIGS. 23 and 24, another example trap device 2 may include a trap body 200 that is configured as a delta-shaped trap (i.e., a trapezoidal shape trap). In the illustrated example, the trap body 200 may have a top wall 250, and the clip plate 302 of the adapter module may be mounted to the top wall 250 of the trap body 200 through bolt-fastening. Specifically, each of the clip plate 302 and the top wall 250 may be formed with a number of bolt holes for enabling bolts to extend therethrough, therefore removably securing the monitor module 4 on the top wall 250 of the example trap device 2 via the adapter module 3.

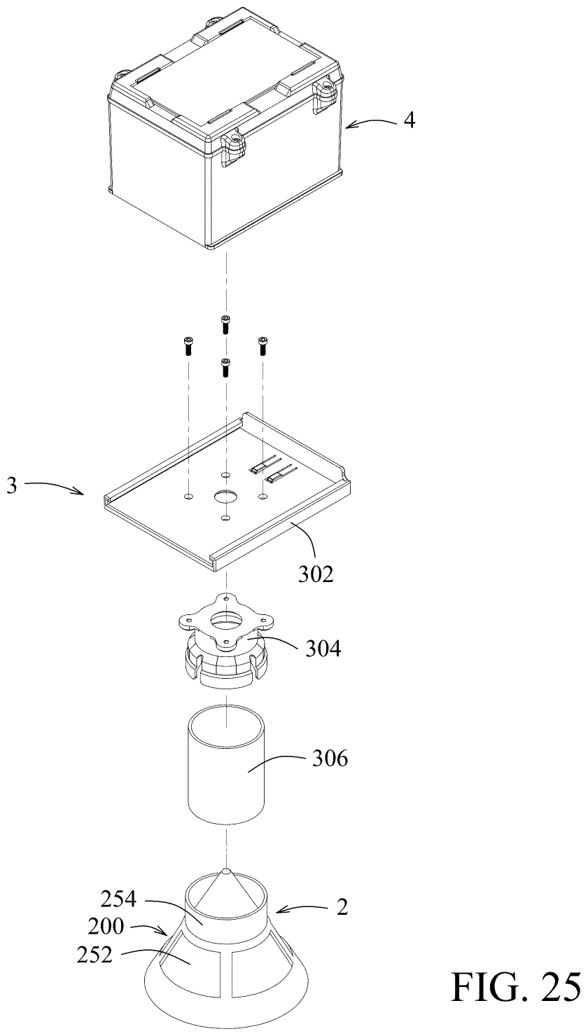

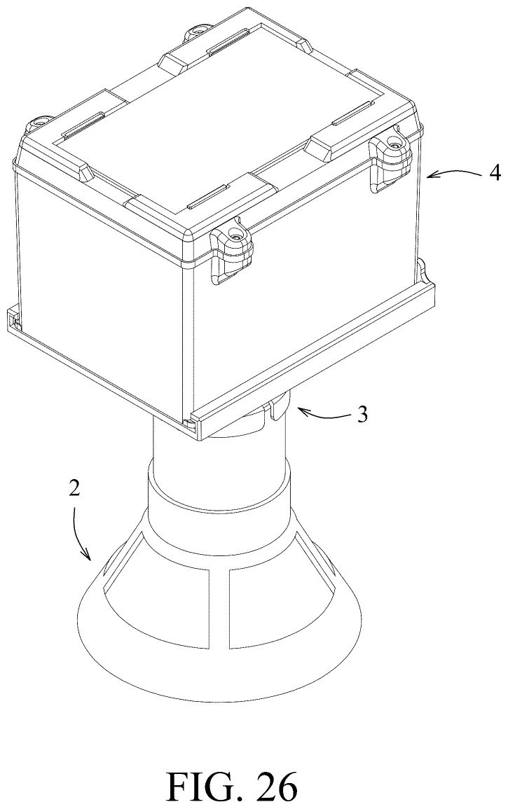

Referring to FIGS. 25 and 26, another example trap device 2 may include a trap body 200 that is configured as a pyramid-shaped trap. In some examples, the trap body 200 may be made through an injection molding technique.

The example trap body 200 may include a bottom cone component 252 that tapers upward and that has a top through hole at the top, and a top cylinder 254 that surrounds the bottom cone component 252. The adapter module 3 may further include a tube member 306 that is coupled to the top cylinder 254, and that cooperates with the bottom cone component 252 and the top cylinder 254 to define a trapping space. The top through hole of the bottom cone component 252 enables specific pests (weevils such as plum curculio, pecan weevil, white pine weevil, etc.) to move therethrough from a bottom of the bottom cone component 252 and into the trapping space in the top cylinder 254 and the tube member 306. In some examples, the tube member 306 may be transparent.

In the illustrated example, the adapter module 3 may further include a holder 304 that holds the tube member 306 and that encloses a top opening of the tube member 306. Specifically, both the clip plate 302 and the holder 304 are formed with a number of bolt holes for enabling bolts to extend therethrough, therefore securing the monitor module 4 onto the trap device 2 via the adapter module 3. In some examples, the holder 304 may be further formed with a central hole for allowing the camera module 202 (see FIG. 2) of the monitor module 4 to capture images inside the top cylinder 254. In a modification of the trap device 2, a hollow truncated-cone formed from a mesh fabric may be attached to the bottom of the bottom cone component 252. As such, the pests may be lured to climb up via an inner surface of the hollow truncated-cone or fly upwards via an inner space of the hollow truncated-cone, and then move through the through hole of the bottom cone component 252 into the trapping space in the top cylinder 254 and the tube member 306.

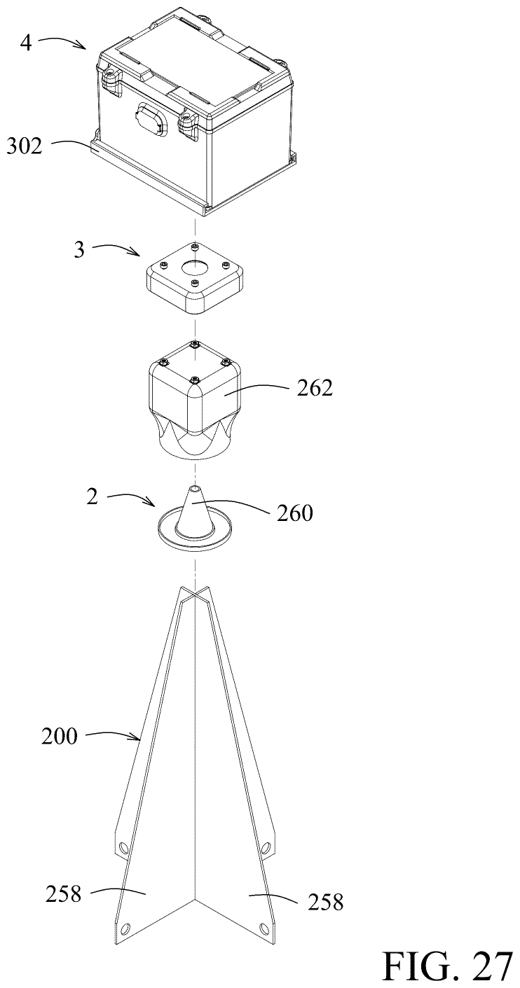

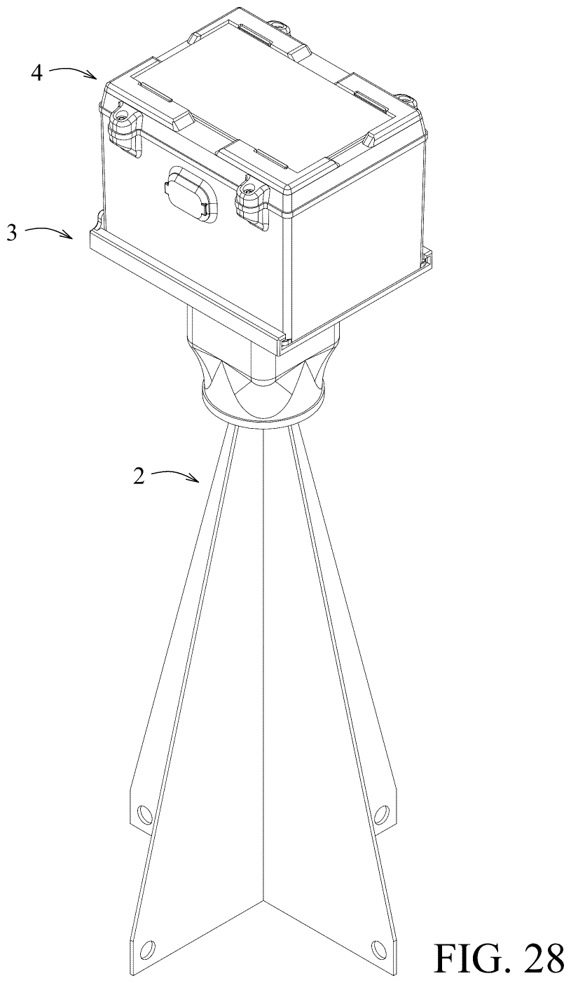

Referring to FIGS. 27 and 28, another example trap device 2 may include a trap body 200 that is configured as a deadinn trap. The example trap body 200 may include two interconnecting base boards 258 that are crossed together to be placed on a surface (e.g., on the ground, a tree, etc.), an upper cone 260 that is placed above the base boards 258 and that is formed with at least one through hole at a top thereof, and a trapping box 262 that covers the top of the upper cone 260. In use, the pests (e.g., stink bug) may be lured to climb up from the base boards 258 or fly upwards through the through hole of the upper cone 260 into the trapping box 262. The through hole may be specifically designed such that the pests inside the trapping box 262 cannot get out from the therethrough.

The monitor module 4 is to be separably attached to the deadinn trap. Specifically, the clip board 302 of the adapter module 3 and a top surface of the trapping box 262 are formed with a number of bolt holes for enabling bolts to extend through the adapter module 3 and the trapping box 262.

Referring back to FIGS. 25 and 26, in a modification of the pyramid-shaped trap, two interconnecting base boards that are crossed together, as shown in FIGS. 27 and 28, may be attached to the bottom of the bottom cone component 252. As such, the pests may be lured to climb up from the base boards and via an inner surface of the bottom cone component 252, and then move through the through hole of the bottom cone component 252 into the trapping space in the top cylinder 254 and the tube member 306.

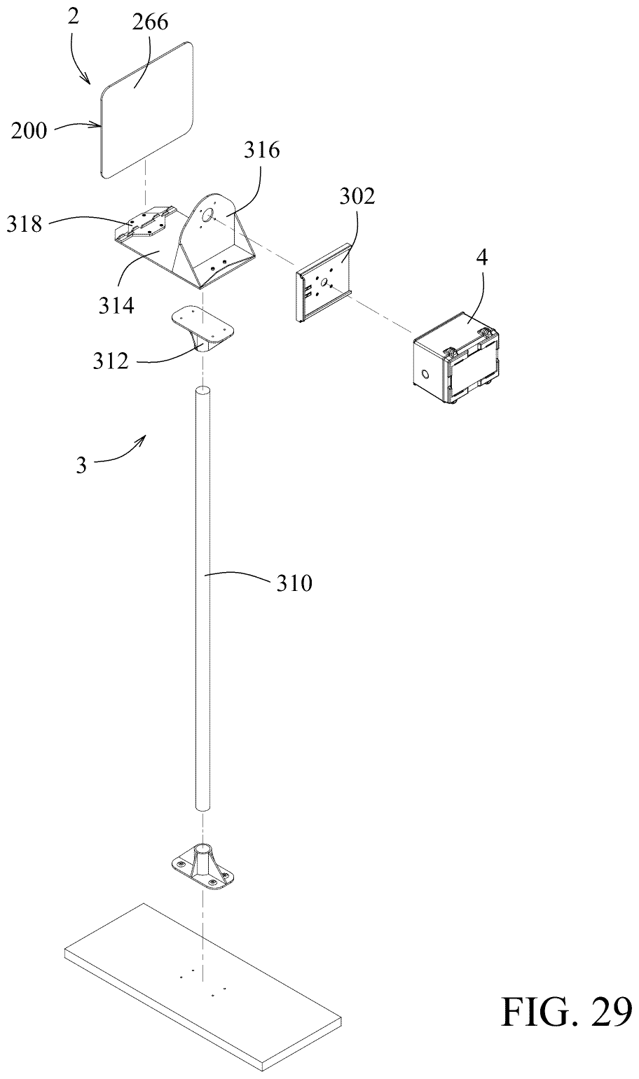

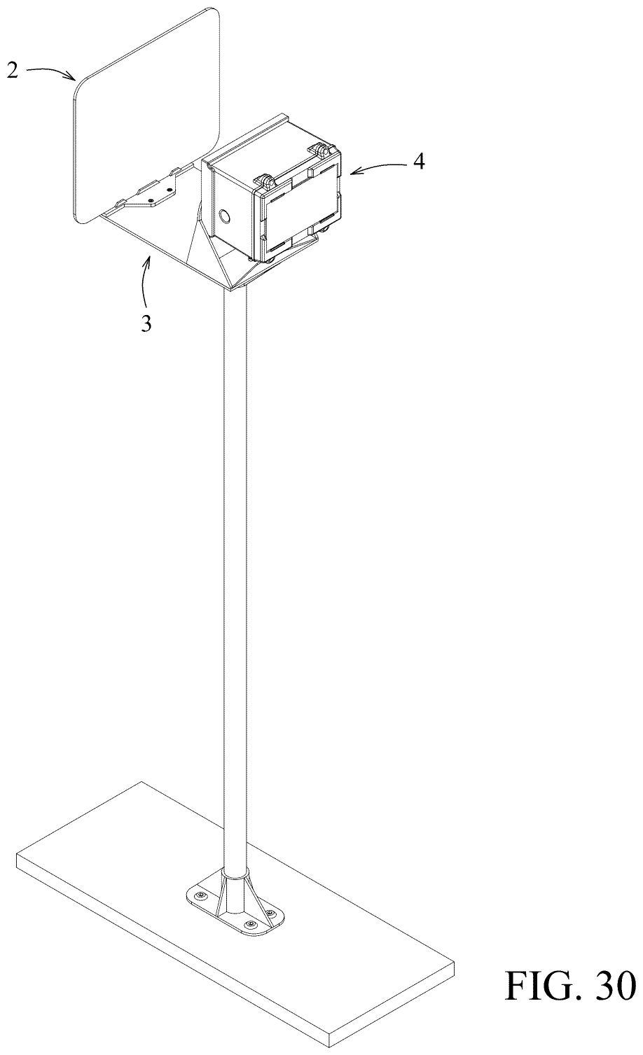

Referring to FIGS. 29 and 30, another example trap device 2 may include a trap body 200 that is configured as a sideway plate trap. For example, the trap body 200 may include a plate 266. In some examples, a yellow sticky board may be clipped on the plate 266. In the illustrated example, the adapter module 3 may further include a mounting pole 310 (e.g., a wooden pole), a mounting mechanism 312 that is connected to a top end of the mounting pole 310, a placement platform 314 that is mounted on the mounting mechanism 312, a monitor connecting component 316 that is mounted on the placement platform 314, and a plate connecting component 318 that is mounted on the placement platform 314, that is spaced apart from the monitor connecting component 316, and that is for connecting the plate 266 onto the placement platform 314 using, for example, clips. It is noted that, in the example illustrated in FIGS. 29 and 30, the plate 266 is placed vertically. In other examples, the plate 266 may be placed in other manners different from the above.

The monitor module 4 is to be separably attached to the sideway plate trap. Specifically, the clip plate 302 of the adapter module 3 and the monitor connecting component 316 are formed with a number of bolt holes for enabling bolts to extend through the adapter module 3 and the monitor connecting component 316, therefore separably attaching the monitor module 4 onto the monitor connecting component 316.

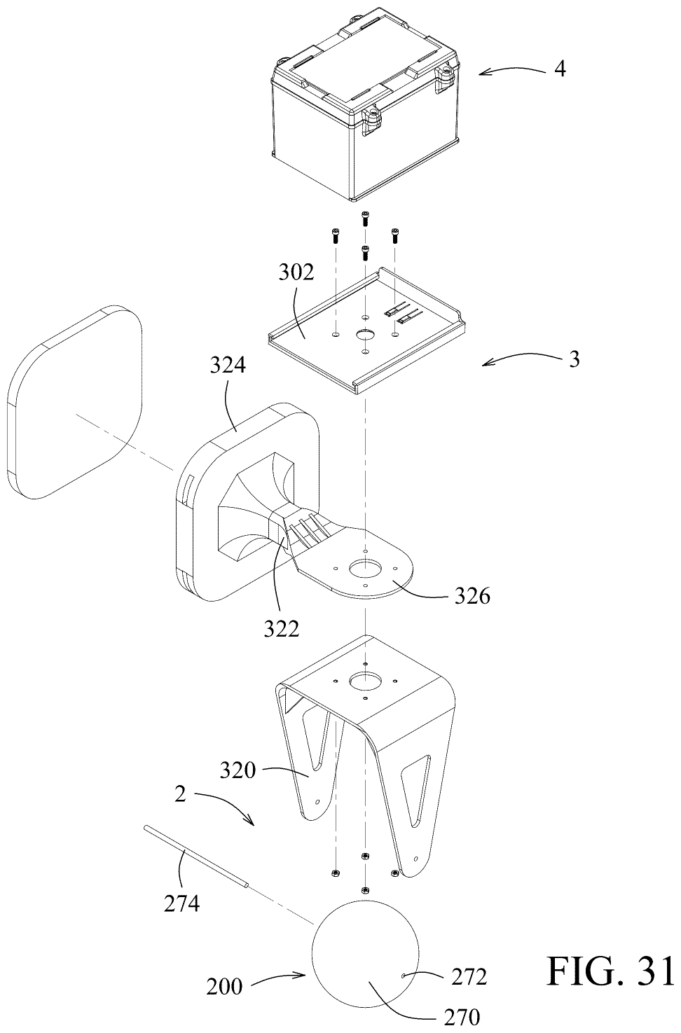

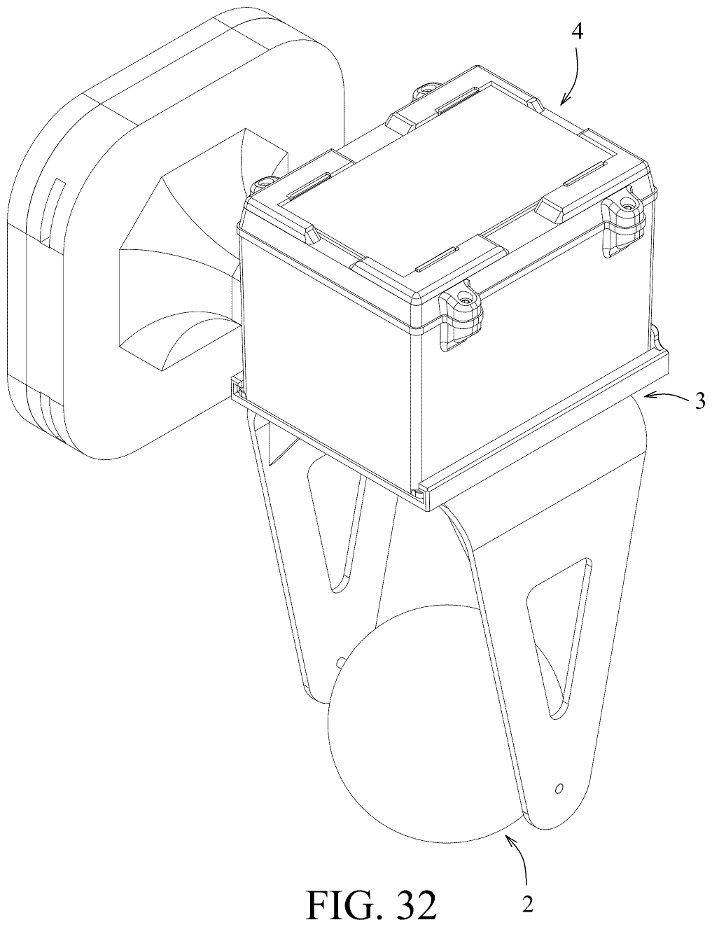

Referring to FIGS. 31 and 32, another example trap device 2 may include a trap body 200 that is configured as a red ball trap. For example, the trap body 200 may include a sphere 270 with a shape and color similar to an apple for luring pests such as apple maggot. In some examples, adhesive may be applied on a surface of the sphere 270 for trapping the pests. Generally, the red ball trap is to be fixed onto, for example, an apple tree. In the illustrated example, the adapter module 3 may further include a clamping element 320 for clamping the sphere 270, and a tree connecting element 322 that have a contacting part 324 for connecting onto a trunk or a branch of the apple tree, and a supporting part 326 extending from the contacting part 324 and extending between the clip plate 302 and the clamping element 320.

The monitor module 4 is to be separably attached to the red ball trap. Specifically, each of the clip plate 302, the supporting part 326 and the clamping element 320 of the adapter module 3 are formed with a number of bolt holes for enabling bolts to extend through the clip plate 302, the supporting part 326 and the clamping element 320, therefore separably attaching the monitor module 4 onto the sphere 270 via the adapter module 3. In some examples, the sphere 270 may be formed with a central hole 272, and a supporting rod 274 connected to the trunk or the branch of the apple tree may be employed to extend through the central hole 272 of the sphere 270 for better holding the sphere 270.

After the tree connecting element 322 is secured onto the trunk or the branch of the apple tree, the sphere 270 may be suspended in the air and be supported by the clamping element 320. The weight of the monitor module 4 and the sphere 270 may be supported by the supporting part 326 that extends from the contacting part 324. In some examples, hose clamp(s) and/or supporting stand(s) may be employed to auxiliarily support the example adapter module 3 and the red ball trap.

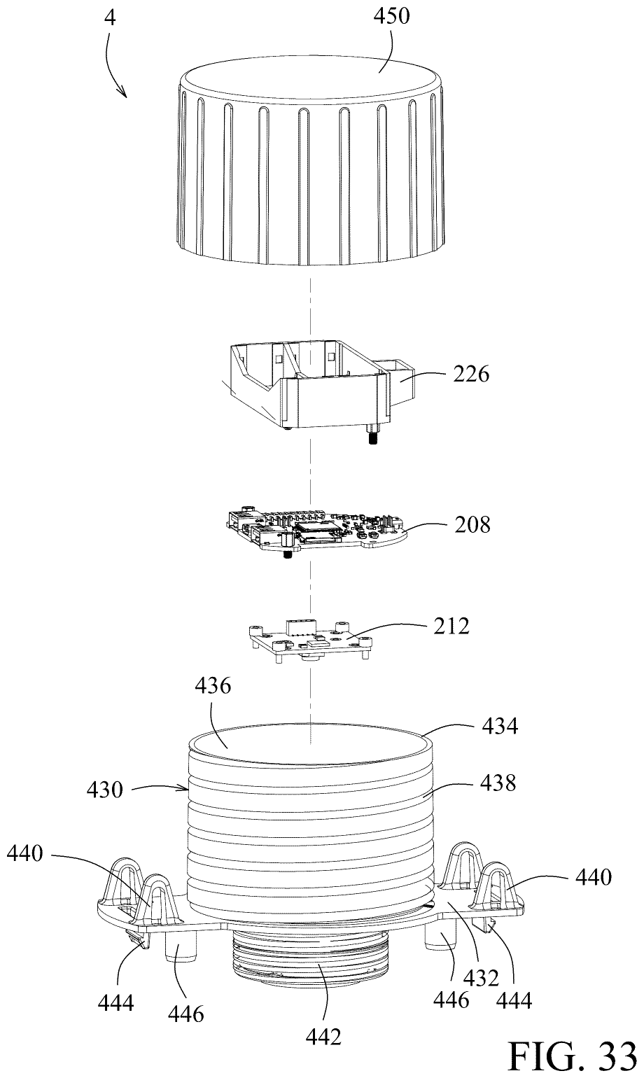

Referring to FIG. 33, in some examples, the monitor module 4 may include a casing 430, a cap 450, a battery case 226, a main board 208 and a camera module 212. The casing 430 may have a base plate 432, a tubular wall 434 connected to the base plate 432 and defines a retaining space 436 therein. The battery case 226, the main board 208 and the camera module 212 may be disposed in the retaining space 436. In the illustrated example, the battery case 226 permits at least one battery to be put therein, and cooperates with the battery to serve as a power supply unit. In some examples, a connectivity module may be disposed on the main board 208. In some examples, the monitor module 4 may include an extension port that is disposed in the retaining space 436. The cap 450 may be mounted to the tubular wall 434 to close the retaining space 436. In some examples, the tubular wall 434 may have an outer thread 438, and the cap 450 may have an inner thread that threadedly engages the outer thread 438 of the tubular wall 434. The monitor module 4 may have a monitor engaging structure that is separately coupled to the adapter module 3. In some examples, the monitor engaging structure may include a pair of flexible hooked arms 444 that are disposed on the base plate 432 and that are spaced apart from each other. In some examples, the flexible hooked arms 444 and the base plate 432 may be integrally formed as one piece. In some examples, the monitor engaging structure may include a threaded connecting protrusion 442 that protrudes from the base plate 432. In some examples, the threaded connecting protrusion 442 and the base plate 432 may be integrally formed as one piece. In some examples, the monitor engaging structure may include a pair of positioning posts 446 that protrude from the base plate 432. In some examples, the positioning posts 446 and the base plate 432 may be integrally formed as one piece. In some examples, the monitor module 4 may have a plurality of lugs 440 disposed on the base plate 432. In some examples, the lugs 440 and the base plate 432 may be integrally formed as one piece.

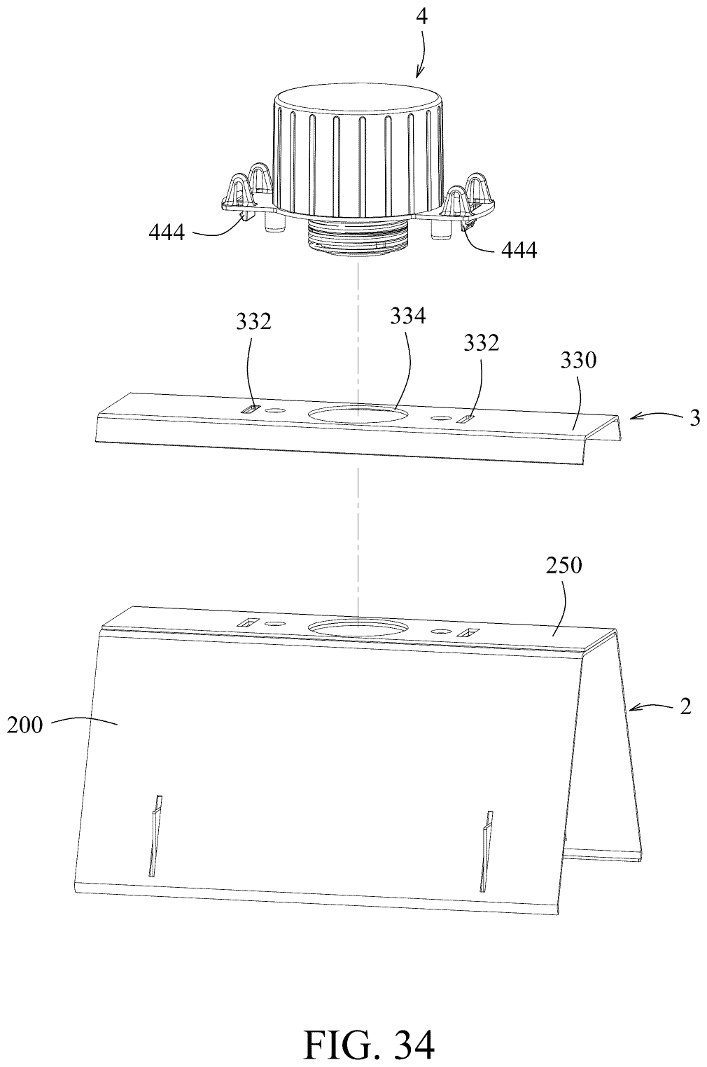

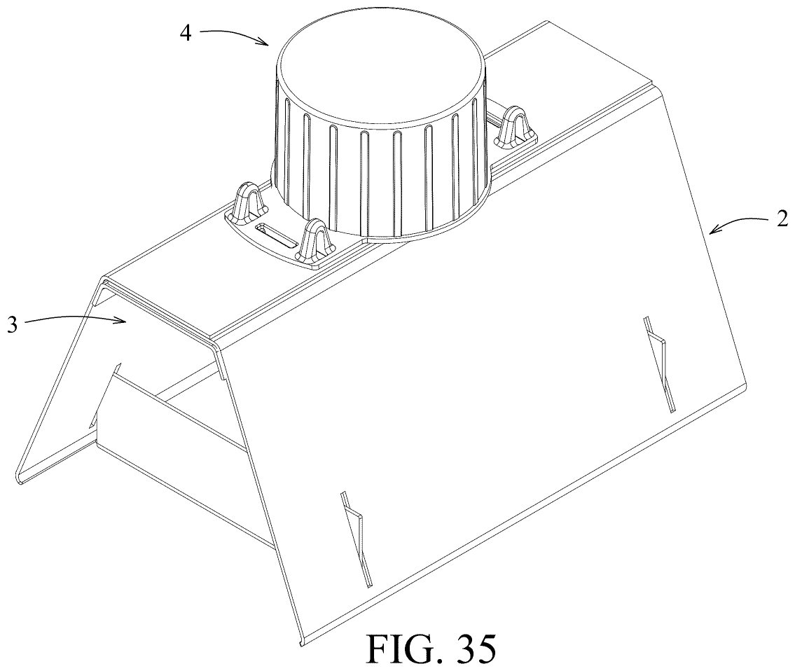

Referring to FIGS. 34 and 35, an example trap device 2 may include a trap body 200 that is configured as a delta-shaped trap (i.e., a trapezoidal shape trap) and that has a top wall 250. The adapter module 3 may include a clamp plate 330 that is formed with two spaced-apart engaging holes 332 that serve as the adapter engaging structure. The clamp plate 330 may be disposed below the top wall 250 of the delta-shaped trap. The monitor module 4 may have a pair of flexible hooked arms 444, and may be disposed above the top wall 250 with the flexible hooked arms 444 extending through the top wall 250 to respectively and separably engage with the engaging holes 332 of the clamp plate 330. In some examples, the clamp plate 330 may be further formed with a through hole 334 for allowing the camera module 202 of the monitor module 4 to capture images inside the delta-shaped trap.

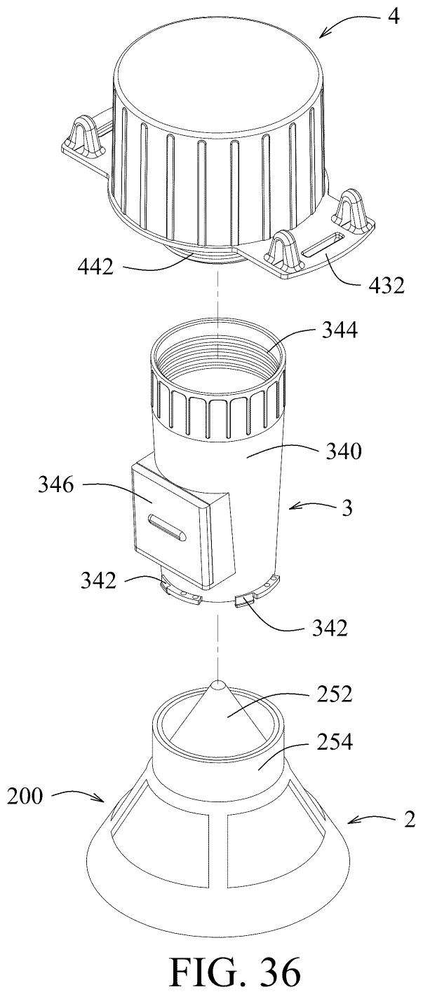

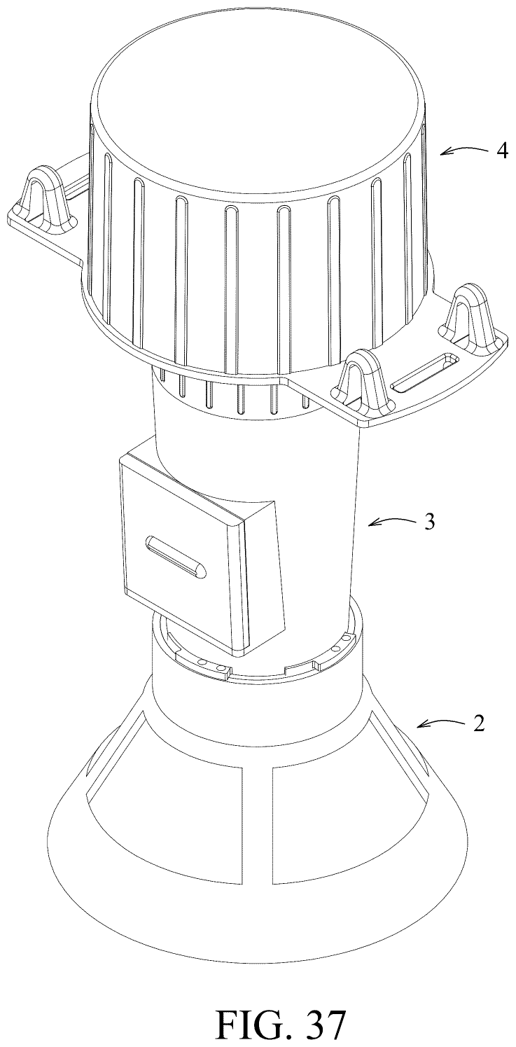

Referring to FIGS. 36 and 37, another example trap device 2 may include a trap body 200 that is configured as a pyramid-shaped trap. The example trap body 200 may include a cone component 252 that tapers upward and that has a top through hole at a top portion thereof, a top cylinder 254 that surrounds the top portion of the cone component 252. The top through hole of the cone component 252 enables specific pests and/or insects (weevils such as plum curculio, pecan weevil, white pine weevil, etc.) climbing up from the bottom of the cone component 252 to move therethrough. In a modification of the pyramid-shaped trap, a hollow truncated-cone formed from a mesh fabric may be attached to the bottom of the cone component 252. In another modification of the pyramid-shaped trap, two interconnecting base boards that are crossed together, as shown in FIGS. 27 and 28, May be attached to the bottom of the cone component 252.

In the illustrated example, the adapter module 3 may include a connecting tube 340 that is connected between the monitor module 4 and the trap body 200. In some examples, the connecting tube 340 may have a plurality of resilient hooks 342, and a threaded portion 344 that serves as the adapter engaging structure. The resilient hooks 342 may be coupled to the top cylinder 254 so as to interconnect the adapter module 3 and the trap body 200. The monitor module 4 may have a threaded connecting protrusion 442 that protrudes from the base plate 432 and that threadedly engages with the threaded portion 344 of the connecting tube 340 so as to separably interconnect the monitor module 4 and the adapter module 3. The connecting tube 340, the top cylinder 254 and the cone component 252 cooperatively define a retaining space thereamong for retaining pests moving through the top through hole of the cone component 252. In some examples, the adapter module 3 may further include a lid 346, and the connecting tube 340 may be formed with an opening that is removably covered by the lid 346.

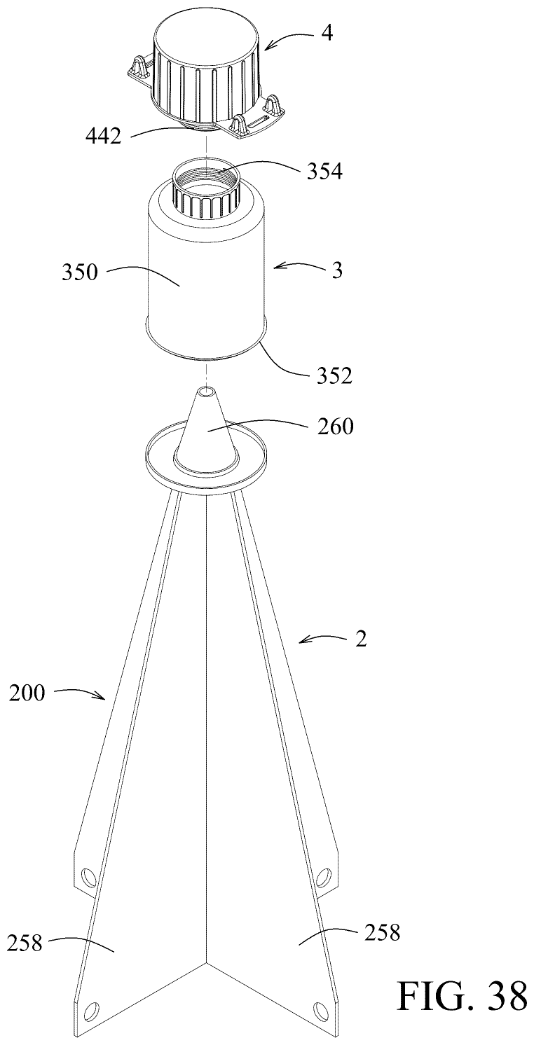

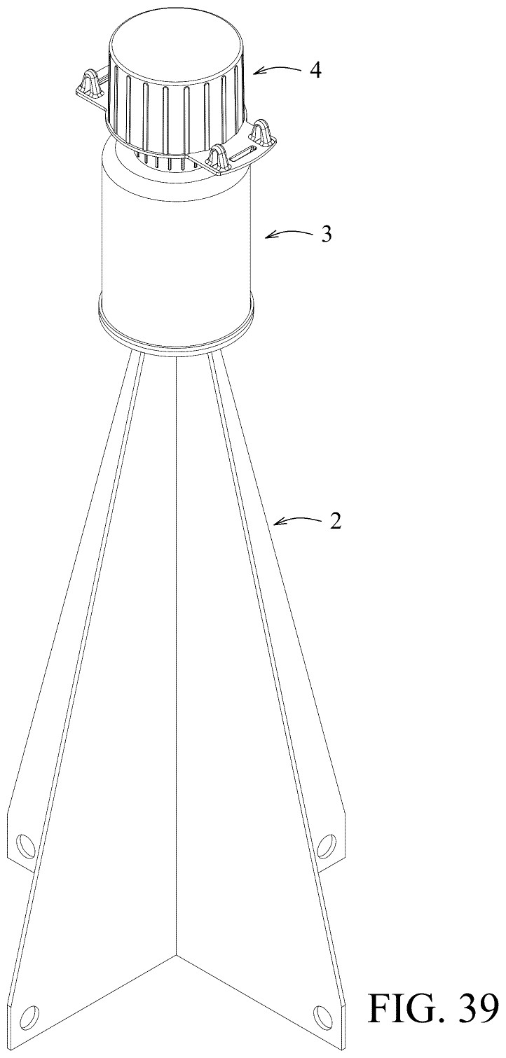

Referring to FIGS. 38 and 39, another example trap device 2 may include a trap body 200 that is configured as a deadinn trap. The example trap body 200 may include two interconnecting base boards 258 that are crossed together to be placed on a surface (e.g., on the ground, a tree, etc.), an upper cone 260 that is placed above the base boards 258 and that is formed with at least one through hole at a top thereof.

In the illustrated example, the adapter module 3 may include a connecting tube 350 that is connected between the monitor module 4 and the trap body 200. In some examples, the connecting tube 350 may have a connecting flange 352, and a threaded portion 354 that serve as the adapter engaging structure. The connecting flange 352 may be coupled to the upper cone 260 so as to interconnect the adapter module 3 and the trap body 200. The monitor module 4 may have a threaded connecting protrusion 442 that protrudes from the base plate 432 and that threadedly engages with the threaded portion 354 of the connecting tube 350 so as to separably interconnect the monitor module 4 and the adapter module 3. The connecting tube 350 and the upper cone 260 cooperatively define a retaining space therebetween. In use, the pests (e.g., stink bug) may be lured to climb up from the base boards 258 or fly upwards through the through hole of the upper cone 260 into the retaining space defined by the connecting tube 350 and the upper cone 260. The through hole of the upper cone 260 may be specifically designed such that the pests inside the retaining space cannot get out from the therethrough.

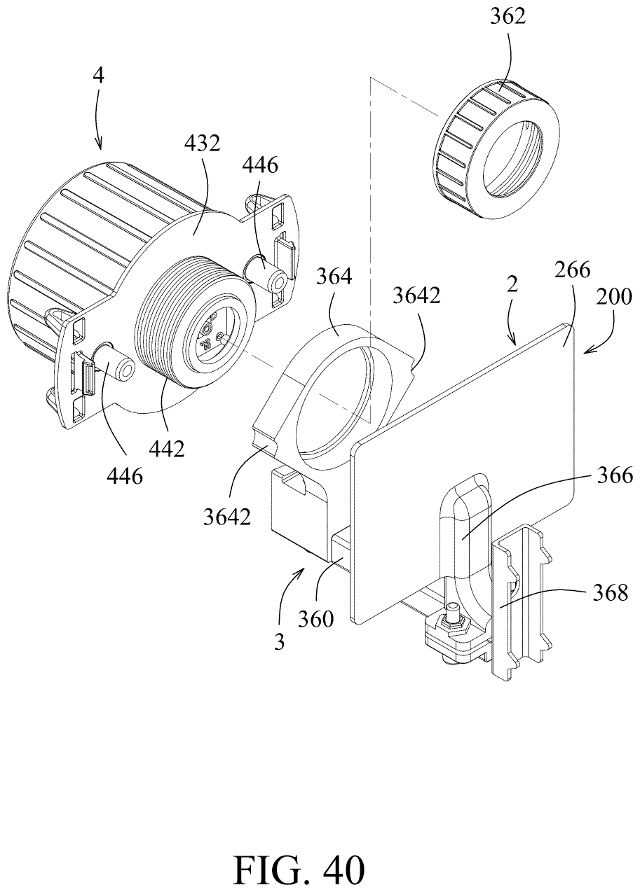

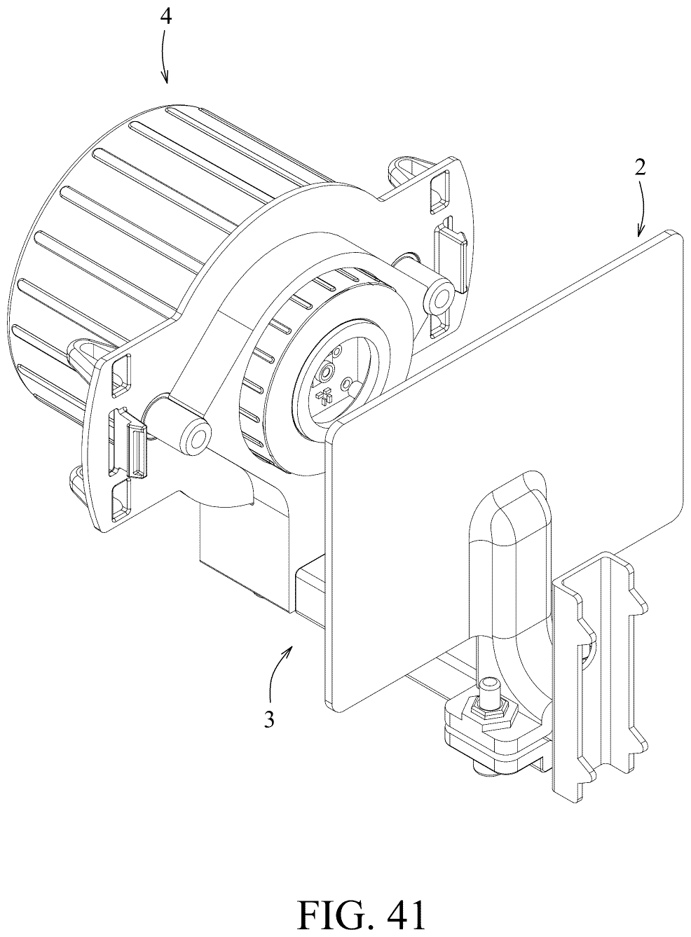

Referring to FIGS. 40 and 41, another example trap device 2 may include a trap body 200 that is configured as a sideway plate trap. For example, the trap body 200 may include a plate 266. In some examples, a yellow sticky board may be clipped onto the plate 266. In the illustrated example, the adapter module 3 may include a support rack 360 and a nut component 362. The support rack 360 may have a monitor connecting portion 364 to which the monitor module 4 is mounted, a plate connecting portion 366 that is spaced apart from the monitor connecting portion 364 and that permits the plate 266 to be mounted thereon, and a stand connecting portion 368 that is located at one side of the plate connecting portion 366 opposite to the monitor connecting portion 364. In some examples, the stand connecting portion 368 may have a plurality of spike structures. It is noted that, in the example illustrated in FIGS. 40 and 41, the plate 266 is placed vertically. In other examples, the plate 266 may be placed in other manners different from the above. In practice, the support rack 360 may be attached to a support stand, or a branch or a trunk of a tree using hose clamp(s).

The monitor module 4 is to be separably attached to the sideway plate trap. In some examples, the monitor connecting portion 364 may have an annulus structure. The monitor module 4 may have a threaded connecting protrusion 442 that protrudes from the base plate 432 and that extends through the annulus structure of the monitor connecting portion 364 before the nut component 362 of the adapter module 3 threadedly engages therewith. As such, the monitor module 4 is separably mounted to the adapter module 3. The monitor connecting portion 364 and the nut component 362 cooperatively serve as the adapter engaging structure. After assembly, the monitor module 4 may be oriented such that the camera module 212 (see FIG. 33) faces the plate 266. In some examples, the monitor connecting portion 364 may have a plurality of position notches 3642. The monitor module 4 may further have a plurality of position posts 446 that respectively engage the position notches 3642 to limit rotation of the monitor module 4 relative to the adapter module 3.

It is noted that the above examples are an incomplete list of possible traps devices that can be used with the adapter module 3 as described above, and are not intended to limit the use of other trap devices that are not listed in the above examples.

In the description above, for the purposes of explanation, numerous specific details have been set forth in order to provide a thorough understanding of the example(s). It will be apparent, however, to one skilled in the art, that one or more other examples May be practiced without some of these specific details. It should also be appreciated that reference throughout this specification to “one example,” “an example,” an example with an indication of an ordinal number and so forth means that a particular feature, structure, or characteristic may be included in the practice of the disclosure. It should be further appreciated that in the description, various features are sometimes grouped together in a single example, figure, or description thereof for the purpose of streamlining the disclosure and aiding in the understanding of various inventive aspects; such does not mean that every one of these features needs to be practiced with the presence of all the other features. In other words, in any described example, when implementation of one or more features or specific details does not affect implementation of another one or more features or specific details, said one or more features may be singled out and practiced alone without said another one or more features or specific details. It should be further noted that one or more features or specific details from one example may be practiced together with one or more features or specific details from another example, where appropriate, in the practice of the disclosure.

While the disclosure has been described in connection with what is (are) considered the exemplary example(s), it is understood that this disclosure is not limited to the disclosed example(s) but is intended to cover various arrangements included within the spirit and scope of the broadest interpretation so as to encompass all such modifications and equivalent arrangements.

What is claimed is:

1. A monitoring apparatus adapted to be attached to a trap device, comprising:
an adapter module adapted to be attached to the trap device; and
a monitor module including a casing that is separably attached to the adapter module, and a core system that is disposed in the casing, the core system including a main board and a connectivity module, the connectivity module being coupled to the main board for communication with an external device.

2. The monitoring apparatus as claimed in claim 1, wherein the core system further includes a camera module that is coupled to the main board and that is adapted for capturing an image in the trap device.

3. The monitoring apparatus as claimed in claim 1, wherein the core system further includes a power supply unit for providing electric power.

4. The monitoring apparatus as claimed in claim 1, wherein the adapter module has an adapter engaging structure, the monitor module having a monitor engaging structure that is operable to engage the adapter engaging structure for positioning the monitor module relative to the adapter module, the monitor engaging structure including at least one flexible hooked arm, the adapter engaging structure including at least one engaging hole that permits the at least one flexible hooked arm to separably engage therewith.

5. The monitoring apparatus as claimed in claim 1, wherein the adapter module has an adapter engaging structure, the monitor module having a monitor engaging structure that is operable to engage the adapter engaging structure for positioning the monitor module relative to the adapter module, the monitor engaging structure including a threaded connecting protrusion, the adapter engaging structure including a threaded portion that is separably engaged with the threaded connecting protrusion.

6. The monitoring apparatus as claimed in claim 1, wherein the adapter module has an adapter engaging structure, the monitor module having a monitor engaging structure that is operable to engage the adapter engaging structure for positioning the monitor module relative to the adapter module, the monitor engaging structure including a threaded connecting protrusion, the adapter engaging structure including an annular structure that permits the threaded connecting protrusion to extend therethrough, and a nut component that separably and threadedly engages the threaded connecting protrusion after the threaded connecting protrusion extends through the annular structure.

7. The monitoring apparatus as claimed in claim 1, the trap device including an extension system, the monitoring apparatus further comprising a connector that includes a plurality of pins and a plurality of contacts, the contacts being disposed on one of the adapter module and the monitor module, the pins being disposed on another one of the adapter module and the monitor module, and being respectively coupled to the contacts when the monitor module is attached to the adapter module so as to coupled the core system to the extension system.

8. A pest trap apparatus comprising:
a trap device including a trap body;
an adapter module attached to the trap device; and
a monitor module including a casing that is separably attached to the adapter module, and a core system that is disposed in the monitor module, the core system including a main board and a connectivity module, the connectivity module being coupled to the main board for communication with an external device.

9. The pest trap apparatus as claimed in claim 8, wherein the trap body includes a container that is divided into a first compartment and a second compartment, the first compartment being adapted to receive a plurality of trays that are stacked on one another, and that are operable to be moved into the second compartment one by one, the second compartment being adapted for a lure to be disposed therein for luring a pest.

10. The pest trap apparatus as claimed in claim 9, wherein the trap device further includes a self-cleaning mechanism that includes a pusher and an actuator, the pusher being operable to move the trays in the first compartment into the second compartment one by one, the actuator being configured to drive movement of the pusher.

11. The pest trap apparatus as claimed in claim 8, further comprising a leveling mechanism that includes a support arm and a wire, the support arm being rotatably mounted to a support stand and holding the trap device distal from the support stand, the wire being tied between the support arm and the support stand after an angle between the support arm and the support stand is adjusted to orient the trap device level.

12. The pest trap apparatus as claimed in claim 8, wherein the trap body has a trapezoidal shape, the adapter module including a clamp plate that is disposed below a top wall of the trap body, the monitor module being separably engaged with the clamp plate.

13. The pest trap apparatus as claimed in claim 8, wherein the trap body includes a cone component that tapers upward and that is formed with a through hole at a top thereof, a top cylinder that is disposed on the cone component, and a hollow truncated-cone that is formed from a mesh fabric and that is attached to the bottom of the cone component, the adapter module including a connecting tube that is connected to the top cylinder, the monitor module being separably engaged with the connecting tube.

14. The pest trap apparatus as claimed in claim 8, wherein the trap body includes two interconnecting base boards that are crossed together and that are adapted to be placed on a surface, and an upper cone that is placed above the base boards and that is formed with a through hole at a top thereof, the adapter module including a connecting tube that is connected to the upper cone, the monitor module being separably engaged with the connecting tube.

15. The pest trap apparatus as claimed in claim 8, wherein the trap body includes a plate, the adapter module including a support rack and a nut component, the support rack having a monitor connecting portion to which the monitor module is mounted, a plate connecting portion that is spaced apart from the monitor connecting portion and that permits the plate to be mounted thereon, and a stand connecting portion that is located at one side of the plate connecting portion opposite to the monitor connecting portion, the monitor module having a threaded connecting protrusion that extend through the monitor connecting portion before the nut component of the adapter module threadedly engages therewith.

16. A self-cleaning mechanism adapted to be mounted to a trap device for pushing a stack of trays one by one, comprising:
a pusher located at a height that corresponds to a height of a bottommost one of the stack of the trays, and operable to move the bottommost one of the stack of the trays; and
an actuator configured to drive movement of the pusher.

17. The self-cleaning mechanism as claimed in claim 16, further comprising first and second limit switches that are spaced apart from each other along a direction in which the pusher is moved, the pusher being adjacent to the first limit switch when at an initial position, wherein:
when the pusher moves from the initial position and comes into contact with the second limit switch, the pusher is determined not to further move toward the second limit switch and to move back toward the first limit switch; and
when the pusher moves back and comes into contact with the first limit switch, the pusher is determined not to further move toward the first limit switch and to stop from moving.

18. The self-cleaning mechanism as claimed in claim 16, further comprising a guide member that is disposed at a height that is capable of containing a height of the bottommost one of the stack of the trays, the guide member having a first part that extends horizontally, and a second part 2884 that extends from the first part in an upward angle toward the stack of the trays.

19. The self-cleaning mechanism as claimed in claim 16, further comprising at least one sliding rail that is adapted to slidably support the bottommost one of the stack of the trays to smoothen the movement of the bottommost one of the stack of the trays driven by the pusher.

20. A method for performing a self-cleaning procedure using the self-cleaning mechanism of claim 16, comprising steps of:
a) placing a tray inside a compartment for trapping pests, and placing a stack of trays outside the compartment, wherein the pusher is at an initial position where the pusher is located beside the stack of trays and at a height that corresponds to a height of a bottommost one of the stack of trays;
b) driving the pusher to move from the initial position toward a pushing position to push the bottommost one of the stack of trays into the compartment, so that the tray in the compartment is pushed out of the compartment by the bottommost one of the stack of trays and that the bottommost one of the stack of trays is adapted for being located in the compartment for trapping pests;
c) returning, after the pusher reaches the pushing position, the pusher back toward the initial position; and
d) stopping, after the pusher reaches the initial position, the pusher from moving.
